(19) United States
(12) Patent Application Publication
(10) Pub. No.: US 2012/0217357 A1
(43) Pub. Date: Aug. 30, 2012

(54) SYSTEM AND METHOD FOR MONITORING CONDITION OF SURFACE SUBJECT TO WEAR

(76) Inventor: Jochen Franke, Beaconsfield (AU)

(21) Appl. No.: 13/395,324

(22) PCT Filed: Sep. 9, 2010
(86) PCT No.: PCT/AU10/01163

§ 371 Date: May 15, 2012

(30) Foreign Application Priority Data
Sep. 9, 2009 (AU) 2009904308

(51) Int. Cl. F16M 11/38; F16M 11/16

(52) U.S. Cl. 248/163.1; 248/176.3

(57) ABSTRACT

A method of and system for, monitoring the condition of a surface of a crushing zone (17) within a crusher (8) having an inlet through which material for crushing is delivered into the crushing zone, the method comprising: positioning a scanning device (31) at a first position to scan a first portion of the surface; and moving the scanning device (31) to a second position to scan a second portion of the surface. The method further comprises moving the scanning device (31) to one or more further positions to scan one or more further portions of the surface to assume all necessary positions for scanning the entire target surface. The scanning device (31) may be positioned externally of the crushing zone or within the crushing zone. Where the scanning device (31) is positioned externally of the crushing zone (17), the scan may be directed through the inlet to the portion of the surface being scanned. The method may further comprise supporting the scanning device (31) at the respective position on a support (30).

### FIELD OF THE INVENTION

The present invention relates to a system and a method for monitoring condition of surfaces of bodies subject to wear or change over time. More specifically, the present invention relates to a system and a method for monitoring of wear within a cavity of the crusher, such as the surfaces of the concave and mantle liners.

### BACKGROUND ART

The following discussion of the background to the invention is intended to facilitate an understanding of the present invention only. It should be appreciated that the discussion is not an acknowledgement or admission that any of the material referred to was published, known or part of the common general knowledge of the person skilled in the art in any jurisdiction as at the priority date of the invention.

In the mining industry, different types of crushers are used to break large solid materials into smaller pieces for further processing. For example, there exists jaw crushers, gyratory crushers, cone crushers and Cylindrical roll crushers such as High Pressure Grinding Rolls (HPGR).

Over time, the mantle liner and the concave liners of the crusher wear and need replacing at an appropriate time in order to maximise crusher efficiency and avoid gusher failure or damages to the crusher. Mantle liners typically wear out quicker than the concave liners, particularly at the lower section. This can be corrected for by adjusting the mantle position upwards during operation using the shaft so as to maintain a steady or constant Closed Side Setting (CSS). If the CSS is not maintained, then undesired variable product sizes and/or production issues may result. Once the mantle can no longer be adjusted upward because the shaft has reached its limit of vertical movement, the mantle is typically replaced by a larger size mantle liner so as to match the now more worn concaves in order to maintain the CSS. Larger mantles continue to be installed in this fashion until the concaves need replacement. Cone crushers function in a similar way, except that mantle and bowl liners are, not necessarily relined at different times.

Usually several size mantles are used during the life cycle of one set of concaves. When the concave liners are new, an undersized mantle is used, when they are worn, a normal size mantle replaces the undersized version, and during the later stages of the concaves' life, an oversized mantle is installed. Depending on the site specific circumstances, less than or more than the three above mentioned sizes, or more than three sizes of mantles may be used in combination with one set of concaves, possibly by reusing mantle matched with the previous set of concaves as the next smaller size.

There are existing methods to check the condition of the mantle and concave liners in order to determine whether a crusher reline is necessary.

In most existing methods, there is a need for a person to access the crusher to take manual measurements during an inspection. However, a difficulty arises when the spider and mantle assembly is in place (typically the case for an inspection) as the person cannot access the crusher cavity. Therefore, it is not possible for the person to reach beyond the upper periphery section of the crusher in order to take manual measurements towards the bottom of the crusher, which is the most critical section to be analysed. In light of safety concerns, it is generally an unacceptable safety risk to lower a person in a harness into a crusher cavity when the mantle is still in place. Similarly, access to cone and jaw crushers is equally prohibitive because of their design and the surrounding infrastructure.

In case of typical fixed plant crusher, further difficulties arise when a person is required to access the crusher because of the safety requirement to completely clear the dump pocket (ROM bin) from any residual ore in order to get to the crusher itself. This is a major undertaking which is further complicated by the need for confined space isolation. This results in additional downtime required, and hence loss in production and revenue.

Examples of existing crusher condition monitoring methods requiring physical access by a person to the crusher include:
Ball Drop Test
Visual or camera inspection
Tape measuring
Ultrasonic Thickness Gauging (UTG)

These existing methods present difficulties as they are only possible to conduct when:
1) The ROM bin is completely cleared of ore;
2) The spider is removed;
3) The mantle/shaft assembly is removed;
4) Confined space isolation for the dump pocket is in place;
5) Confined space isolation for the crusher cavity is in place; and
6) Safety access systems such as steps, ladders, harnesses, scaffolding, and/or custom cavity platforms are available and deployed.

Therefore, with the above existing methods, it is not possible to examine the crusher liners for Wear at any time other than during a mantle reline, which is when the mantle/shaft is removed. As a result, it is not possible to examine the crusher liners for wear during an inspection shutdown, when any of items 1) to 6) listed above are not attained. This means that the only time when the mantle liners can be examined with the above existing methods is when the mantle is being relined anyway.

In addition, the above existing methods cannot provide reliable and accurate results, such as timing of reline. For example, the crusher could be relined more frequently than necessary, resulting in loss of production and extra costs.

### DISCLOSURE OF THE INVENTION

The present application hereby incorporates by reference, in their entirely, International patent applications PCT/AU2005/001630 (International publication WO 2007/000010) and International patent applications PCT/AU2007/001977 (International publication WO 2008/074088), along with their corresponding National Phase applications in various jurisdictions, which means that they should be read and considered by the reader as part of this text and are not repeated in this text merely for reasons of conciseness.

It is an object of the present invention to mitigate or overcome, at least one of the aforementioned problems associated with prior art crusher condition monitoring system or to at least provide an alternative useful system.

According to a first aspect of the invention there is provided a method of monitoring the condition of a surface of a crushing zone within a crusher having an inlet through which material for crushing is delivered into the crushing zone, the method comprising: positioning a scanning device at a first position to scan a first portion of the surface; and moving the scanning device to a second position to scan a second portion of the surface.

Preferably, the method further comprises moving the scanning device to one or more further positions to scan one or more further portions of the surface. In this way, the scanning device can assume all necessary positions for scanning the entire target surface.

Typically, the crushing zone is defined between inner and outer crushing surfaces. The inner crushing surface may be defined by mantle liners and the outer crushing surface is defined by concave liners.

The scanning device preferably comprises a three-dimensional laser scanner.

The scanning device may be positioned externally of the crushing zone or within the crushing zone.

Where the scanning device is positioned externally of the crushing zone, the scan may be directed through the inlet to the portion of the surface being scanned.

The location at which the scanning device is to be positioned for scanning a particular portion of the surface may be ascertained by identifying the respective surface portion to be scanned and projecting from that surface portion outwardly through the crusher inlet to establish a line along which the scanning device should be positioned in order to scan the respective portion through the inlet. This may not necessarily be done physically at the site of the crusher; it may be calculated using available data relating to the crusher and the site at which it is operating.

The method may further comprise supporting the scanning device at the respective position on a support. The support provides a deployment system for the scanning device.

The scanning device may be moved between the respective positions by moving the support or by moving the scanner in relation to the support.

The support may take any appropriate form.

In one arrangement, the support may comprise a frame structure adapted to be positioned above the crusher to support the scanning device.

The frame structure may comprise a plurality of legs adapted to rest on an area about the inlet of the crusher. By way of example, the legs may rest on the crusher spider rim or any other area of the crusher.

The frame structure may comprise an upper frame section supported on three legs. The upper frame section may comprise three frame elements configured to provide a triangular frame portion defining three corners. The deployment system is not limited to a tripod system and further legs can be provided as apparent to a person skilled in the art.

The upper frame section may further comprise an extension portion at one of the corners of the triangular frame portion. The extension portion may comprise an extension arm slidably supported on the triangular frame portion for movement between extended and retracted condition. The extension arm can be selectively locked in any one of a plurality of available positions, between the extended and retracted conditions. A locking mechanism is provided for releasably locking the extension arm in the selected position.

The extension arm may have an outer end to which one of the legs is connected, with the other legs being connected to the other two comers of the triangular frame portion.

Preferably each leg is configured to be of selectively variable length.

Each leg may be provided with a foot adapted to rest on a support surface, with the foot being angularly movable relative to the adjacent portion of the leg to which it is connected to accommodate any inclination in the surface configuration on which it positioned.

The scanning device may be supported on the frame structure in any appropriate way. In particular, the scanning device may be supported on the upper frame section.

The frame structure may be lifted and rotated to shift the scanning device from one position to another.

In another arrangement, the frame structure may incorporate a track along which the scanning device can be moved from one position to another. The scanning device may be mounted on a carriage movable along the track. The track may be configured as a circular track arranged to permit movement of the scanning device around the crusher to assume all necessary positions for scanning the entire target surface.

The frame structure may be deployed in position in any appropriate way; for example, by being lifted into position by an overhead gantry or other crane system available on site at the location at which the crusher is operating.

In yet another arrangement, the support may comprise a portion at the free end of the arm of a rocker breaker available on site at the location at which the crusher is operating. The free end of the arm of the rock breaker may, in use, rest on area about the inlet of the crusher in order to support the scanning device in a stable manner.

In yet another arrangement, the support may comprise a carrier adapted to be lowered into the crushing through the inlet thereof. The carrier may be adapted to engage a surface of the crusher in order to support the scanning device in a stable manner. The carrier may comprise a trolley adapted travel along the concave wall of the crusher. The carrier may be suspended from an overhead gantry or other crane system available on site at the location at which the crusher is operating and lowered into the crusher to engage the concave liners of the crusher.

In yet another arrangement, the support may comprise a frame structure adapted to be lowered into the crushing through the inlet thereof. The frame structure may be adapted to engage between opposed surfaces of the crushing zone (such as between the mantle wall and the concave wall) in order to support the scanning device in a stable manner. The frame structure may be extensible and contractible to accommodate the varying distance between the opposed surfaces of the crushing zone as it travels downwardly and upwardly within the crushing zone. The frame structure may incorporate rollers, wheels, skids or the like to facilitate movement along the two opposed surfaces. The frame structure may be configured as an X-bracket assembly.

In yet another arrangement, the support may comprise a beam adapted to be positioned on the crusher, with the beam being selectively movable whereby the scanning device can assume all necessary positions for scanning the entire target surface.

According to a second aspect of the invention there is provided a method of monitoring the condition of a surface of a crushing zone within a crusher having an inlet through which material for crushing is delivered into the crushing zone, the method comprising: positioning a scanning device at a position to scan a portion of the surface, the location at which the scanning device is to be positioned for scanning the portion of the surface being ascertained by identifying the respective surface portion to be scanned and projecting from that surface portion outwardly through the crusher inlet to establish a line along which the scanning device should be positioned in order to scan the respective portion through the inlet.

According to a third aspect of the invention there is provided system for performing the method according to the first or second aspects of the invention.

According to a fourth aspect of the invention there is provided system monitoring the condition of a surface of a crushing zone within a crusher having an inlet through which material for crushing is delivered into the crushing zone, the system comprising a scanning device and a support for positioning the scanning device at a position to scan a paten of the surface.

The scanning device preferably comprises a three-dimensional laser scanner.

The support may comprise any one of the supports set out above in relation to the first aspect of the invention.

### BRIEF DESCRIPTION OF THE DRAWINGS

Embodiments of the invention will now be described, by way of example only, with reference to the accompanying drawings in which:

FIG. 1 is a schematic sectional view of a typical primary gyratory crusher plant;

FIG. 2 is a schematic sectional view of the gyratory crusher in the gyratory crusher plant shown in FIG. 1;

FIG. 3 is a schematic perspective view of the mantle and concave liners of the crusher shown in FIG. 2;

FIG. 3A is a schematic plan view of the mantle and concave liners of the crusher, shown in FIG. 2, illustrating the OSS and CSS relationship therebetween;

FIG. 4 is a schematic sectional side view of the gyratory crusher plant at which there is in use a system according to invention for monitoring the condition of mantle and concave liners of the gyratory crusher;

FIG. 5 is a schematic sectional side view of the gyratory crusher plant at which there is in use a system according to a first embodiment for monitoring the condition of mantle and concave liners of the gyratory crusher;

FIG. 6 is a fragmentary schematic perspective view illustrating installation of the system according to the first embodiment;

FIG. 7 is a perspective view of a frame structure forming part of the deployment system according to the first embodiment;

FIG. 8 is a schematic sectional side view of the gyratory crusher plant at which there is in use a system according to a second embodiment for monitoring the condition of mantle and concave liners of the gyratory crusher;

FIG. 9 is a schematic view of the system according to the second embodiment;

FIG. 10 is a schematic plan view of the gyratory crusher plant at which there is in use a system according to a third embodiment for monitoring the condition of mantle and concave liners of the gyratory crusher;

FIG. 11 is a schematic sectional side view of the gyratory crusher plant at which there is in use a system according to a fourth embodiment for monitoring the condition of mantle and concave liners of the gyratory crusher;

FIG. 12 is a schematic sectional side view of the gyratory crusher plant at which there is in use a system according to a fifth embodiment for monitoring the condition of mantle and concave liners of the gyratory crusher;

FIG. 13 is a schematic view of a frame structure used in the deployment system according to the fifth embodiment;

FIG. 14 is a schematic sectional side view of the gyratory crusher plant at which there is in use a system according to a sixth embodiment for monitoring the condition of mantle and concave liners of the gyratory crusher;

FIG. 15 is a top view of the crusher illustrating the scanner positions;

FIG. 16 is a top view of the crusher with the spider rim removed;

FIG. 17 is a perspective view of the concave and mantle illustrating the ring of data;

FIG. 18 is a colour-coded representation of the thickness of the mantle liners;

FIG. 19 is a colour-coded representation of the thickness of the mantle liners;

FIG. 20 is a perspective view of the concave liner illustrating a matrix projected onto the concave liner;

FIGS. 21a and 21b illustrates asymmetry wear in an upper row and a lower row of concave liners; and

FIGS. 22a to 22z are various screenshots for typical reports available using the system according to the various embodiments for monitoring the condition of mantle and concave liners of the gyrotary crusher.

### BEST MODE(S) FOR CARRYING OUT THE INVENTION

The best mode for carrying out the invention will now be described with reference to several specific embodiments thereof. The description of each specific embodiment makes reference to the accompanying drawings. Accordingly reference numerals referred to herein are used in the drawings to show the corresponding feature described in the embodiment.

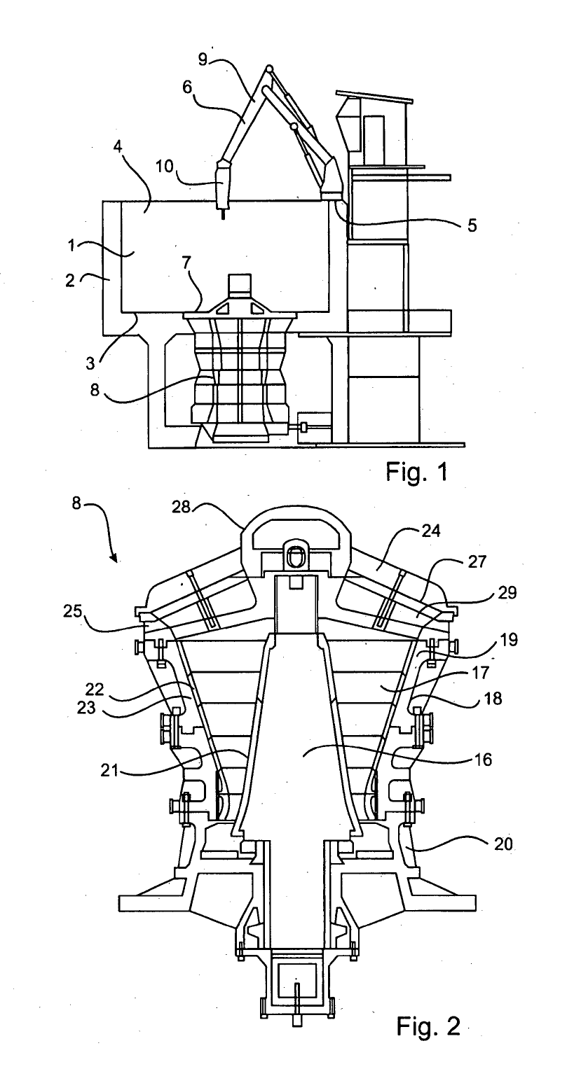

FIG. 1 illustrates a cross-sectional view of a conventional fixed plant crusher set up in a mine site for crushing large solid objects (such as ores) tipped or deposited into a ROM bin into smaller pieces. As shown in FIG. 1, the ROM bin 1 includes side walls 2, a base 3, and an open top 4, substantially forming a confinement area where the large solid objects are tipped or deposited therein.

The base 3 has an opening 7 with which a top section of a crusher, such as a gyratory crusher 8 as shown in FIG. 2, communicates. Along a top edge 5 of one of the side walls of the ROM bin 1, there may be attached a conventional rock breaker 6 having an arm 9 with a hammer 10 attached to an end thereof for breaking up solid objects which may have been jammed in the opening 7. Alternatively, or in addition to the rock breaker 6, there may be installed a fixed plant overhead crane (not shown in FIG. 1) having one or more beams bridged between two structural supports. Typically, a trolley runs along the one or more beams carrying a hoist which is used to lift and reposition heavy and/or large structures. Still alternatively, there may be provided a mobile deployment infrastructure (not shown), for example, including an arm mounted on a heavy vehicle such as a truck.

FIG. 2 illustrates a conventional gyratory crusher 8 used for crushing large solid objects, such as ores, into smaller pieces. The gyratory crusher 8 is one of several types of crushers that can be used for such purpose. Other crushers include, jaw crusher, cone crusher and cylindrical roll crushers (such as high pressure grinding rolls). For ease of understanding, the present invention will only be described with respect to a gyratory crusher. However, it will be apparent to a person skilled in the art that the present invention is not limited to a gyratory crusher and is also applicable to other types of crushers which are within the scope of the present invention. For example, a gyratory crusher includes a mantle having mantle liners thereon and a concave having concave liners thereon. A person skilled in the art would be able to make the resemblance that the concave in gyratory crushers corresponds with the bowl in a cone crusher. Similarly, a person skilled in the art would be able to make the resemblance that the concave in gyratory crushers corresponds with the set of vertically-inclined jaws.

With reference to FIG. 2, the gyratory crusher 8 comprises a downwardly expanding central conical member (or a mantle) 16 extending substantially vertically within the crusher cavity 17 and an outer upwardly expanding frustroconically shaped member hereinafter referred to as a shell 18. The shell 18 may comprise two or more portions, such as, a top shell (or a concave) 19 and a bottom shell 20. One or more mantle liners 21 are provided on and over the surface of the mantle 16 in order to protect the mantle 16 from damage or wear. The mantle liners 21 provide a crushing surface of the crusher 8. One or more concave liners 22 are provided on and over an inner surface 23 of the concave 19 in order to protect the inner surface 23 from damage or wear. The concave liners 22 also provide a crushing surface opposing the mantle liners 21.

A spider assembly 24 comprising a spider 25 having two or more arms extending from a central portion is provided on the top edges of the concave 19. The spider arm is provided with a liner 27 and the central portion is provided with a spider cap 28 so as to protect the spider from damage and wear. The spider 25 defines an inlet 29.

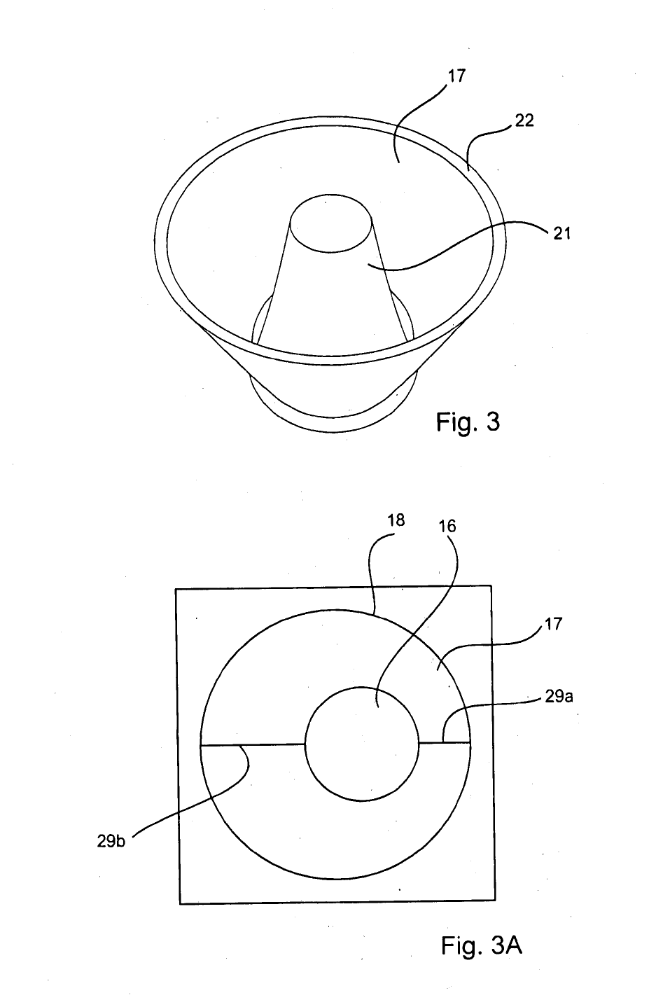

In operation, large solid objects, such as ore, are tipped into the ROM bin 1 which then pass through the inlet 29 defined by the spider 25 between the spider arms and into the crusher cavity 17 for crushing into smaller pieces. The mantle 16 has a small circular movement in an eccentric fashion, whereas the concave 19 is fixed in position. When the ore reaches near the bottom portion of the crusher cavity 17, the ore is crushed by the closing of the gap between the moving mantle liner 21 and the fixed concave liners 22. In particular, the ore is crushed near the bottom of the top shell at location of the Closed Side Setting (CSS) 29a, while crushed ore is allowed to exit the crusher cavity 17 at location of the Open Side Setting (OSS) 29b as for example illustrated in FIG. 3A.

Over time, the mantle liners 21 and the concave liners 22 will wear and will need replacing in order for the crusher 8 to perform in an efficient manner. The crusher 8 will need to be shut down in order to replace the mantle and/or concave liners 21, 22, thus resulting in crusher downtime which is undesirable from an economic point of view. It is important to accurately determine when the mantle and/or concave liners 21, 22 need to be replaced so that the liners 21, 22 are not replaced too early (for example, resulting in liner wastage and unnecessary crusher downtime) and too late (for example, resulting in deterioration in crusher performance and potential damage to the structure of the crusher 8). Therefore, it is desirable to determine an optimal time to replace the mantle and/or concave liners in order to minimise crusher downtime, increase productivity and reduce costs.

According to embodiments of the present invention, there are provided a condition monitoring system and a method) for monitoring the wear of the mantle and concave liners 21, 22 of a crusher 8 without the need for physical access within the crusher cavity 17 by a person as taught in the prior art. As described above, a person skilled in the art can understand that the condition monitoring system and method are not limited to a gyratory crusher and other types of crushers are within the scope of the present invention. The condition monitoring system-and method are described only with respect to a gyratory crusher for the sake of conciseness.

The condition monitoring system monitors the wear of the mantle and concave liners by performing three-dimensional scans of the surfaces of the mantle and concave liners 21, 22 to obtain three-dimensional point cloud data for each scan. Once the point cloud data is collected, the data can then be processed and analysed as described hereinbelow to produce useful technical information and deliverables such as the remaining life of the liners 21, 22 before it should be replaced, the wear rates of different sections of the mantle and concave liners and the position of localised liner failure.

For example, monitoring the wear of the mantle and concave liners 21, 22 provides data to facilitate in determining timing or schedules for adjustments or replacement of the mantle as necessary in order to maintain the CSS and OSS within desirable ranges for effective crushing.

Further, the crusher condition monitoring system and method may facilitate improvement or optimisation in the operational performance of the crusher 8.

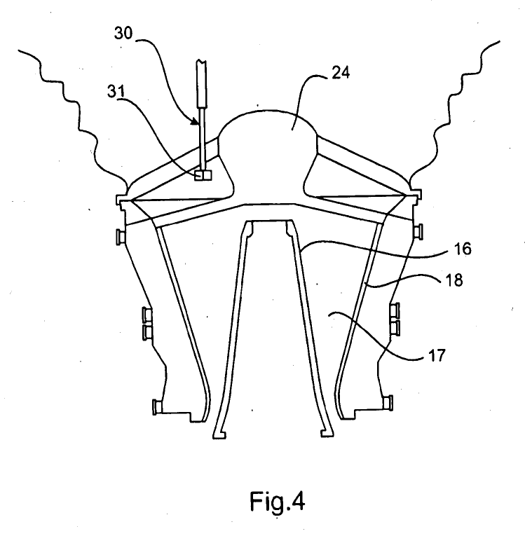

The condition monitoring system comprises a deployment system 30, scanning means such as a scanner 31 and a computer (not shown). The deployment system 30 is configured as a support for support the scanner 31. The deployment system 30 is used for deploying a scanner 31 attached thereo in the vicinity the inlet 29 between the spider arms or into the crusher cavity 17 for scanning the surface of mantle liner 21 and/or concave liner 22, as depicted schematically in FIG. 4. The computer includes data acquisition means, processing means and storage means. The processing means includes data editing means for editing the point cloud data collected by the scanner 31 (such as to filter unwanted points). The processing means may also include a referencing means for the orientation of the point cloud data and the transformation of the point cloud data into a particular co-ordinate system if needed.

Preferably, the scanner 31 is a high precision three-dimensional (3D) laser scanner that collects a large amount of precise 3D point measurements to generate point cloud data by directly measuring distance to a remote surface by time of light laser range-finding. The scanner 31 should be able to capture data in a spherical or near-spherical field of view (FOV) and able to capture a dense dataset in the order of several millions of points throughout the full FOV within a short time period, such as a few minutes.

Alternatively or in addition to using a laser scanner to generate point cloud data of a structure, other means capable of generating point cloud data can be used such as a photogrammetry system, which are within the scope of the present invention. For conciseness, the present invention will only be described with respect to a laser scanner 31.

In a preferred embodiment, the deployment system 30 utilises one of the following existing deployment infrastructures associated with conventional crushers in order to minimise costs:
Fixed Plant Overhead Crane, which is typically already installed at large size primary crushers
Fixed Plant Rock Breaker Arm, which is typically already installed adjacent the ROM bin for large size primary crushers
Mobile Deployment Infrastructure (e.g. arm mounted on truck, etc.)

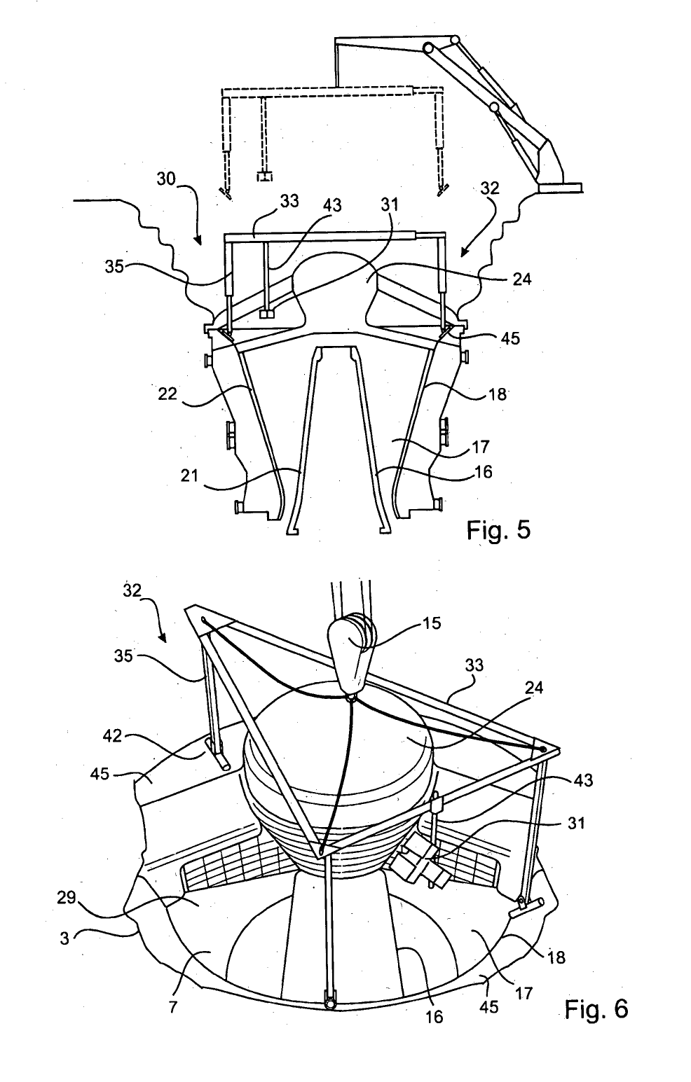

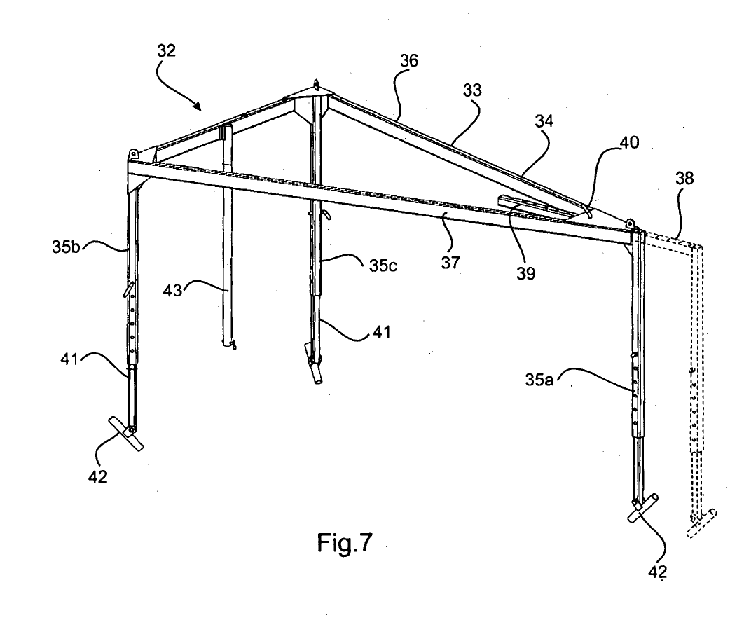

According to a first embodiment of the present invention as shown in FIGS. 5, 6 and 7, the deployment system 30 is configured as a multi-legged or tripod deployment system 32. The tripod deployment system 32 is configured as a frame structure 33 comprising an upper frame section 34 supported on three legs 35. The upper frame section 34 comprises three frame elements 36 configured to provide a triangular frame portion 37 defining three corners. The deployment system 32 is not limited to a tripod system and further legs can be provided as apparent to a person skilled in the art.

The upper frame section 34 further comprises an extension portion 38 at one of the corners of the triangular frame portion. The extension portion 38 comprises an extension arm 39 slidably supported on the triangular frame portion 37 for movement between extended and retracted condition. The extension arm 39 can be selectively locked in any one of a plurality of available positions, between the extended and retracted conditions. A locking mechanism 40 is provided for releasably locking the extension arm 39 in the selected position.

The extension arm 39 has an outer end to which the first leg 35a is connected. The second and third legs 35b, 35c are connected to the other two corners of the triangular frame portion 37. With this arrangement, the spacing between the first leg 35a and the other two legs 35b, 35c can be selectively varied according to the requirements of the location at which the frame structure 33 is positioned. In particular, the position of the first leg 35a can be moved laterally with respect to the other two legs 35b, 35c.

Each leg 35 is configured to be of selectively variable length. In this embodiment, each leg is of telescopic construction for this purpose. Specifically, each leg comprises telescopic sections 41 adapted to be selectively locked together in various available positions.

Each leg 35 is provided with a foot 42 adapted to rest on a support surface at the base 3 of the. ROM bin 1 or on an adjacent portion of the crusher. The foot 42 is angularly movable relative to the adjacent portion of the leg to which it is connected to accommodate any inclination in the surface configuration on which it positioned.

The scanner 31 as described hereinabove is installed at a position on the frame structure 33. In the arrangement shown, the scanner 31 is supported on a support post 43 suspended from the upper frame section 34. The supported post 43 is adjustable in position on the upper frame section 34, according to the requirements at the crusher site. The support post 43 can be mounted on any one of the frame elements 36 and is selectively movable along the particular frame element 36 from which it is supported to achieve the desired final position of the scanner 31.

In operation, the tripod deployment system 32 is conveyed into the ROM bin 1. In the arrangement shown, the tripod deployment system 32 is loaded onto a hoist 15 suspended from the arm 9 of the rock breaker 6 and lowered into the ROM bin 1. In another arrangement, the tripod deployment system 32 may be loaded onto a hoist suspended from the overhead crane at the crusher site. Once loaded, the tripod deployment system 32 can then be moved to various locations within the bounds of the arm 9 of the rock breaker 6 or the fixed plant overhead crane 11 in a manner known to a person skilled in the art. According to the present embodiment, the tripod deployment system 32 is moved to a position above the crusher 8 and then lowered until each of the foot 42 stability rest onto an outer rim portion 45 of the spider 25 or in the vicinity thereof.

When the tripod deployment system 32 is in a rest state on the outer rim portion 45, the scanner 31 can then be control remotely to perform a three-dimensional scan of the surrounding environment, thereby capturing three-dimensional point cloud data including data associated with a section of the surface of the mantle and concave liners.

In such manner, a section of the liners 21, 22 can be captured by the scanner 31. However, there will be other sections of the surface of the liners 21, 22 which are out of the line of sight of the scanner 31 during the first scan as described above. In order to capture the other sections of the surface of the liners 21, 22, the deployment system 32 is lifted from rest, and rotated so as to move the scanner 31 to another area for scanning. For example, the scanner is rotated around 120° and then the tripod deployment system 32 is lowered and rested upon the outer rim 45 of the spider 25 in a manner similar as described above. After capturing 3D point cloud data at that location, the tripod deployment system 32 is again lifted and rotated another 120°, and then lowered and rested upon the outer rim 45 of the spider 25 for capturing further 3D point cloud data at that location. It is apparent to a person skilled in the art that more or less than the three scanning locations described above, can be undertaken and the angle of rotation can be adjusted without going beyond the scope of the invention.

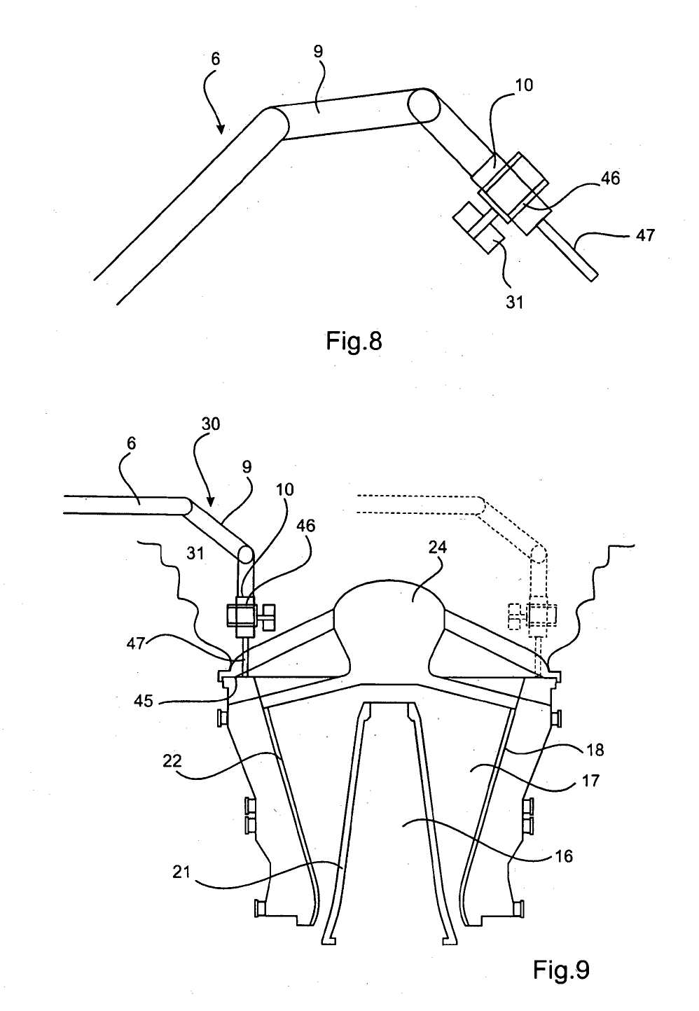

In a second embodiment of the present invention, which is shown in FIGS. 8 and 9, the deployment system 30 utilises the rock breaker 6. Specifically, the scanner 31 is secured to the hammer 10 of the rock breaker 6 as by way of a mounting bracket 46.

Once the scanner 31 is secured to the hammer 10, the rock breaker 6 is moved such that a tip 47 of the hammer 10 rests on a portion of the outer rim 45 of the spider 25 or in the vicinity thereof. It is important for the tip 47 to be rested in such a manner so that the scanner 31 can be maintained in stable state. The scanner 31 can then be control remotely to perform a three-dimensional (3D) scan of the surrounding environment, thereby capturing 3D point cloud data including data associated with a portion of the liners surface 21, 22.

In such manner, a portion of the liners surface 21, 22 can be captured by the scanner 31. However, there will be other portions of the liners surface 21, 22 which are out of the line of sight of the scanner 31 during the first scan as described above and thus not captured. In order to capture such other portions of the liners surface, the rock breaker 6 is lifted from the rest position to a location where a person can rearrangement the scanner 31 such that the scanner 31 will be capable of capturing the other portions of the liners surface. For example, the scanner 31 is move about 180° around the hammer 10. Once the scanner 31 is rearranged and fixed in its new location, the rock breaker 6 is moved to, for example, an opposite side of the outer rim 45 of the spider so as to capture the further portions of the liners surface 21, 22. At this new location, the scanner 31 can then be control remotely to perform another 3D scan of the surrounding environment, thereby capturing 3D point cloud data including data associated with the other portion of the liners surface 21, 22. In FIG. 8, the scanner 31 is shown in one position, and depicted in a further position in outline.

Alternatively, instead of physically repositioning the scanner 31 around the hammer 10 (involving a manual operation by a person), the scanner 31 can be installed on a conveying section capable of being remotely controlled to move the scanner 31 around the hammer 10, thus, eliminating the need for a person to physically reposition the scanner 31 by hand.

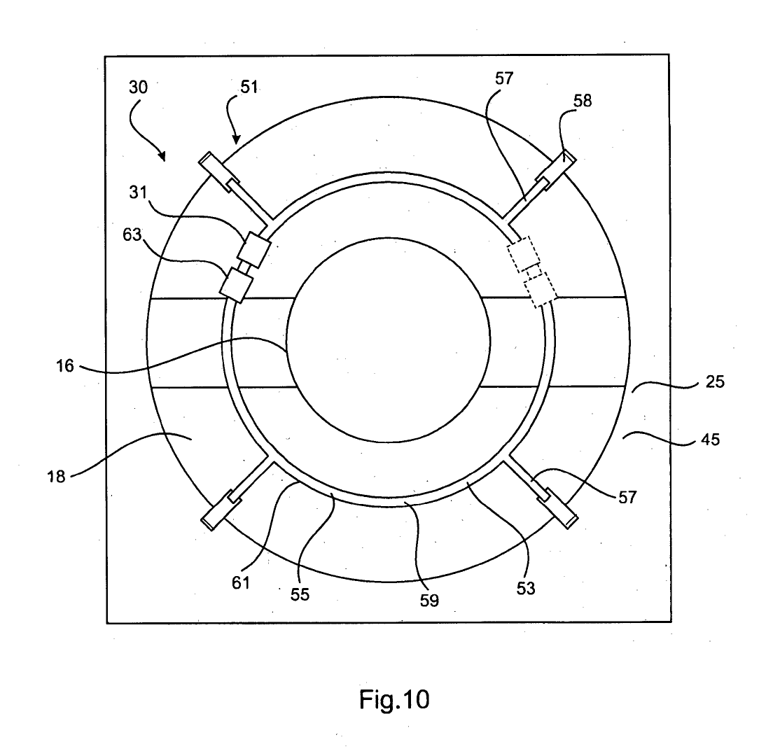

In a third embodiment of the present invention, which is shown in FIG. 10, there is provided a deployment system 30 involving a variation of the tripod deployment system 32 as described in the first embodiment. In this embodiment, the deployment system 30 comprises a rail deployment system 51 is configured as a frame structure 53 comprising an upper frame section 55 supported on legs 57. In the arrangement shown there are four legs, although three or more legs can be employed.

The upper frame section 55 comprises a rail 59 defining a track 61. In the arrangement shown, the rail 59 is circular, although other rail configurations are possible.

A trolley 63 is mounted on the rail 59 for movement along the track 61. The trolley 63 is adapted to support the scanner 31.

Each leg 57 is configured to be of selectively variable length. In this embodiment, each leg 57 is of telescopic construction for this purpose. Specifically, each leg 57 comprises telescopic sections (not shown) adapted to be selectively locked together in various available positions.

Each leg 57 is provided with a foot 58 adapted to stability rest on a support surface, such as on the outer rim portion 45 of the spider 25 or in the vicinity thereof. The foot 58 is angularly movable relative to the adjacent portion of the leg to which it is connected to accommodate any inclination in the surface configuration on which it positioned.

The rail deployment system 51 is attached to a hoist of the fixed plant overhead crane in a manner apparent to a person skilled in the art. Using the fixed plant overhead crane, the rail deployment system 51 is positioned over the crusher such that the legs 57 stably rest on the outer rim 45 of the spider 25 or in the vicinity thereof. When the rail deployment system 51 has been rested, the trolley 63 can be controlled remotely to move along the rail 59 to a particular location above the crusher cavity 17 desired for the scanner 31 to perform a three-dimensional scan of the surrounding environment. In FIG. 10, the scanner 31 is shown in one position, and depicted in a further position in outline.

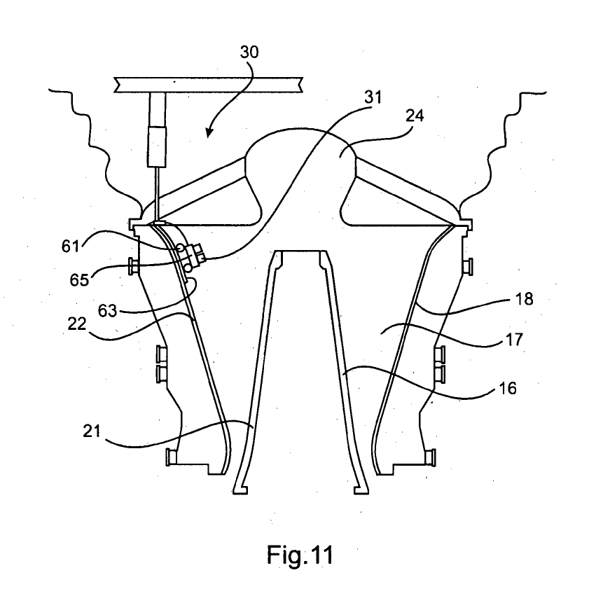

In a fourth embodiment of the present invention, which is shown in FIG. 11, the deployment system 30 comprises a rigid track system 61 adapted to be lowered by a hoist an overhead crane 11 until it rests on an upper portion of the concave liners 22. The track system 61 comprises at least a track 63 and a trolley 65 which travels along the track 63. The track 63 can be straight or curved in a manner in conformity with an upper portion of the concave liners 22.

The scanner 31 is mounted on the trolley 65 and can be moved along the track 48 to a suitable position for performing a three-dimensional scan of the surrounding environment. For example, the scanner 31 is lowered along the track 63 such that there is a line of sight from the scanner 31 to the bottom of the crusher cavity 17. It is crucial to capture data of the liners surface 21, 22 near the bottom of the crusher cavity 17 as the majority of the crushing activity occurs there.

In such manner, a portion of the liners surface 21, 22 can be captured by the scanner 31. However, there will be other portions of the liners surface 21, 22 which will be out of the line of sight of the scanner 31 during the first scan as described above and thus not captured. In order to capture such other portions of the liners surface, the overhead crane 11 lifts the track system 61 and moves it to other locations along the upper portion of the concave liners 22 so that the other portions of the liners surface 21, 22 not capture during the first scan can subsequently be captured.

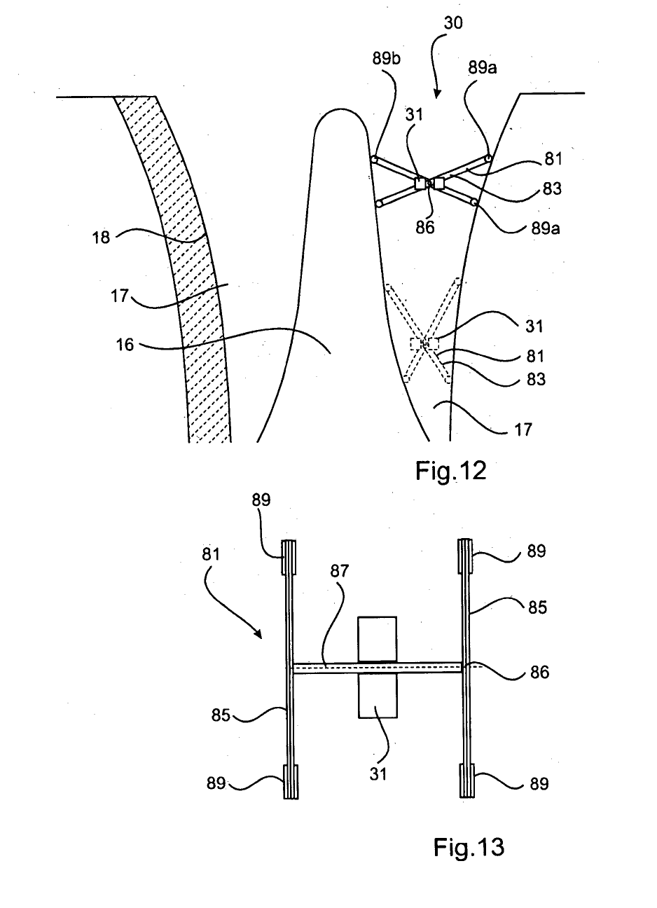

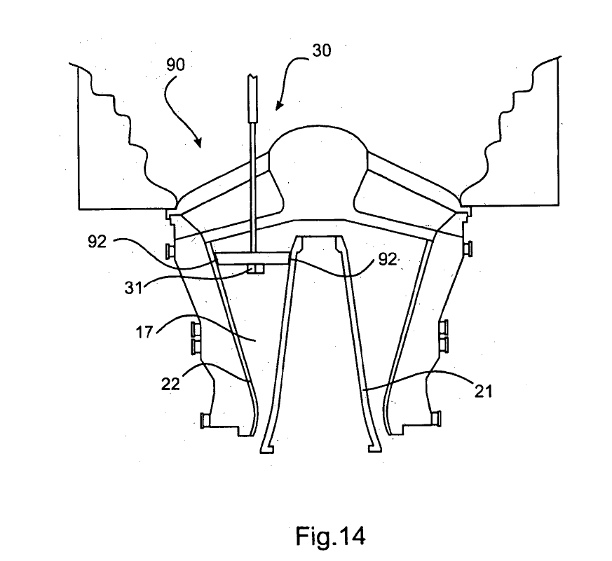

In a fifth embodiment of the present invention, which is shown in FIGS. 12 and 13, the deployment system 30 comprises a frame structure 81 configured as an X-bracket assembly 83. The X-bracket assembly 83 comprises two side portions 85 and a traverse beam 87 extending between the two side portions 86. Each of the two side portions 85 include two beams connected together in cross formation at pivot 86. The ends of the two beams have wheels 89 attached thereto. In FIG. 12, the frame structure 81 and scanner 31 are shown in one position, and depicted in a further position in outline

The X-bracket assembly 83 is adapted to be lowered into the crusher cavity 17 such that the wheels 89a on one side engage on the surface of the concave liner and the wheels 89b an the opposing side engage on the surface of the mantle liner. The scanner 31 is installed at position along the traverse beam 87. As the assembly 83 is lowered into the crusher cavity 17 by, for example, an overhead crane, the assembly 83 would contract and the wheels 89 moves along the liner surfaces 21, 22, meanwhile the scanner is maintained in a central position. The assembly 83 further includes a mechanism for stopping the rotation of the X-bracket about the X-bracket pivot points 86 so that the assembly 83 will rest at a desired vertical position inside the crusher cavity 17.

Accordingly, due to such configuration of the X-bracket assembly 83, the scanner 31 can be rest at a desired vertical position inside the crusher cavity for performing a 3D scan of the surrounding environment.

In a sixth embodiment of the present invention, which is shown in FIG. 14, the deployment system 30 comprises a simple yet effective cross-beam deployment system 90.

The cross beam system 90 comprises a cross-beam 91 having opposing ends 92. The cross-beam 91 to be lowered into the crusher cavity 17 by for example a overhead crane until the ends 92 of the cross beam 59 engage with respective liner surfaces. The scanner 31 is attached at a position along the cross beam 59.

In a seventh embodiment, which is not shown, the deployment system comprises a moving arm system. The moving arm is deployed with a terrestrial laser scanner having a three-dimensional field of view. The base of an arm rests on the spider cap or any other appropriate fashion known to the skilled person. The arm then rotates with the scanner 31 attached at its end around the base to position the scanner at the suitable required location around the spider.

The method or process for monitoring the wear condition of a crusher according to embodiments of the present invention will now described in greater details below.

The process can be generally categorised into the following steps:
i. Scanning of crusher cavity 17 (i.e., the surface of the concave and mantle liners 22, 21).
ii. Registration of individual scans for joining the individual scans in order to create a continuous three dimensional representation of a surface (e.g., mantle and concave liners surface 21, 22).
iii. Segmentation of data into different components (e.g., separate concave liner 22 and mantle liner 21 data).
iv. Obtaining base reference data (i.e., data representing the surface of the concave 19 and mantle 16 without the liners in place (i.e., bare concave and mantle)).
v. Determining the thickness of concave and mantle liners 22, 21 at various locations.

The step of scanning the crusher cavity 17 is performed in order to obtain point cloud data representing the surface of the concave and mantle liners 22, 21. In this step, a laser scanner 31 is deployed or held at a series of positions in the vicinity above the inlet 29 or within the crusher cavity 17 for performing a series of scans of the crusher cavity 17 using any suitable one of the above-described deployment systems of the present invention or other variants apparent to a person skilled in the art. For conciseness, the process will only be described with respect to the deployment system 30 depicted in FIG. 5. However, it will be apparent to a person skilled in the art that the present invention is not limited to such a deployment system.

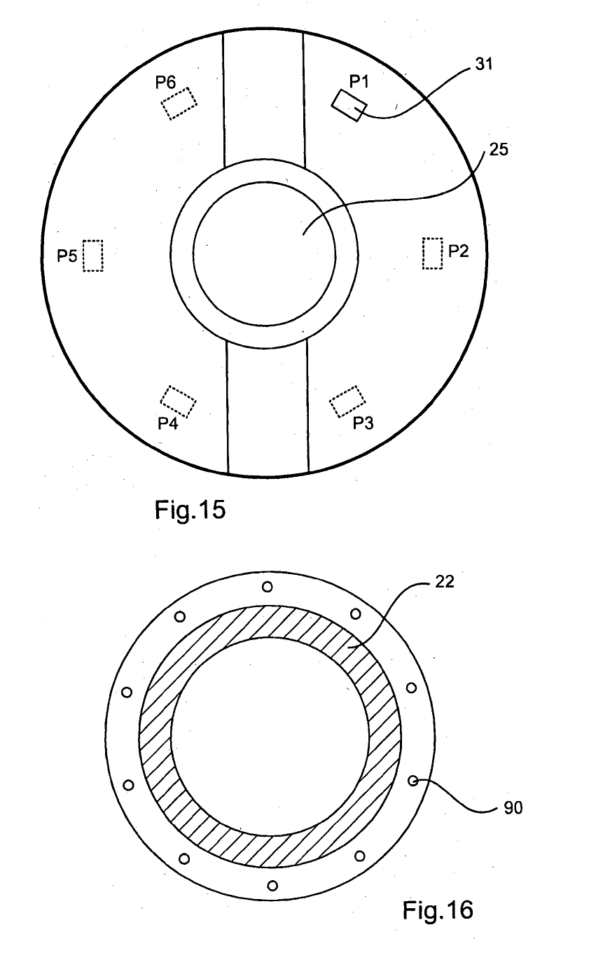

A series of scans is required when the mantle 16 is in place in order to achieve a substantially complete field of view of the surface of the concave and mantle liners 22, 21. FIG. 15 illustrates a series of six positions at which the scanner 31 is held by the deployment system 30 to perform a series of scans of the crusher cavity 17. With the deployment system 30 of FIG. 6, the scanner 31 is held at positions above the inlet 29 such that a line of sight of the scanner 31 is able to project to surfaces of the concave and mantle liners 22, 21 at the location of the CSS 29a or the OSS 29b. The ore in the crusher cavity is crushed near the bottom of the concave 19 and mantle 16 at location of the CSS, while crushed ore is allowed to exit the crusher cavity 17 at locating of the OSS. Therefore, it is important to ensure that the scanner 31 is positioned to be able to capture the liner surface condition of this critical area.

In an embodiment, in order to identify possible scanner set up locations, a graphical projection of line of sight coming from the very bottom edge of the concave/mantle 19, 16 through the crusher cavity 17 is used. Identifying scanner set up positions in this way enables line of sight to the bottom of the crusher 6 so as to provide data collection on this critical area. In addition, it allows identification of set up positions that do not require isolation or shutdown procedures to get access to.

To obtain the series of individual scans of the crusher cavity 17, the scanner 31 may first be positioned above the inlet 29 near a spider arm at location P1 as shown in FIG. 15 to perform a scan. After a scan is performed at location P1, the scanner 31 may then be moved to a position above the opening substantially in between the two spider arms at location P2 as shown in FIG. 15 to perform another scan. After a scan is performed at location P2, the scanner 31 may then be moved to a position above the opening near the other spider arm at location P3 as shown in FIG. 15 to perform yet another scan. The scanner 31 is subsequently moved to locations P4, P5 and P6 as shown in FIG. 15 for performing further scans at each of those locations.

The raw point cloud data of each of the scans is collected by the data acquisition means and stored in the storage means to be processed.

As a series of individual scans are collected, it is necessary to combine the individual scans together by registration in order to form a complete or continuous three-dimensional point cloud data of the surface of the concave and mantle liners 22, 21.

According to embodiments of the present invention, the complete three-dimensional point cloud data can be obtained via the processing means by a number of ways. For example, an absolute positioning system such as an Inertial Measurement Unit (IMU) or a laser tracking system can be used. Other systems for absolute co-ordinate positioning apparent to a person skilled in the art may also be applied. Alternatively, a surface to surface registration of the individual scans can be performed.

In the case of an IMU, the IMU is attached to the scanner 31 or mounted in the vicinity of the scanner 31 in a fixed spaced relationship thereto. The IMU include inertial sensors such as angular rate sensor (e.g., gyros) and acceleration sensors (e.g., accelerometers). Based on these sensors, the IMU can be used for tracking the position of the scanner 31 relative to a known reference point (e.g., a survey monument or marker). For example, the reference point may be configured to have a co-ordinate system (X-axis, Y-axis and Z axis) such as (0, 0, 0). Therefore, since the IMU continuously tracks the change in position of the scanner relative to the known reference point, the co-ordinate system of the scanner at each of locations P1 to P6 would be known and can be recorded. That is, the IMU provides absolute position referencing with each scan. Thus, the co-ordinate system of the point cloud data obtained by each scan would be known. As a result, the point cloud data associated with each scan can be directly registered by the processing means to form a complete three-dimensional point cloud data of the surface of concave and mantle liners 22, 21.

An advantage associated with the IMU method is that it eliminates the time consuming task of scan registration using traditional techniques by allowing for direct registration of the individual scans.

A laser tracking system can similarly be used to track the co-ordinate system of the scanner 31 at each of locations P1 to P6 such that the co-ordinate system of the point cloud data associated with each scan would also be known.

If an absolute positioning system is not used to track the position of the scanner 31 relative to a known reference point, it will be necessary to perform a surface to surface registration of the individual scans in order to form a complete or continuous three-dimensional point cloud data of the surface of the concave and mantle liners 22, 21. In this process, a number of fixed structures (preferably non-wearing) of the crusher are identified and used such that adjacent scans with overlapping fields of view can be joined and oriented in the crusher coordinate system by matching the identified fixed structures. For example, as shown in FIG. 16, under the spider rim, there are normally bolt holes 90 spaced apart along the upper periphery of the concave 19 for receiving bolts to secure the spider rim to the concave 19. Accordingly, once the spider rim is removed, the bolt holes 90 may serve as fixed structures to be used when registering adjacent scans. For example, each scans at locations P1 to P6 will capture a portion of the surface of the concave and mantle liners 22, 21 as well as the bolt holes 90 along the upper periphery of the concave 19. Therefore, when registering the adjacent scans performed at locations P1 and P2, the same bolt holes 90 in the overlapping fields of view are identified in the adjacent scans and are matched when joining the adjacent scans together. The other adjacent scans are registered in the same manner. Once all of the adjacent scans are registered, a complete or continuous three-dimensional point cloud data of the surface of the mantle and concave liners is obtained.

Alternatively, instead of indentifying fixed structures of the crusher, dedicated fixed structures can be installed at suitable locations on or in the vicinity of the crusher 6 for referencing purposes in a similar manner as described above.

The complete three-dimensional point cloud data of the surface of mantle and concave liners 21, 22 is edited by the data editing means in order to filter unwanted points (e.g., spurious points from outside of the crusher cavity 17) and segment the point cloud data into mantle liner 21 data and concave liner 22 data. In an embodiment, the filtering and segmenting steps are performed manually by a person using the data editing means. In another embodiment, the filtering and segmenting steps can be automated as apparent to a person skilled in the art.

According to an embodiment of the present invention, a base reference data representing the surface of the bare concave 19 and mantle 16. (i.e., base reference) is obtained in order to determine the relative displacement of the surface of the liners 22, 21 with respect to the base reference. The relative displacement of the surface of the liners 22, 21 with respect to the base reference at any one point would therefore represent the thickness of the liner at that point.

The base reference data may be obtained from a number of techniques according to embodiments of the present invention depending on the surrounding circumstances.

For example, if a CAD model of the crusher is available, the base reference data can simply be extracted from the CAD data. In this case, the base reference data and the point cloud data representing the surface of the mantle and concave liners 21, 22 are each reference to their own co-ordinate system. Therefore, in order to derive accurate displacement data indicative of the thickness of mantle and concave liners 21, 22 at any particular point, the sets of data would need to be correlated. In particular, the point cloud data representing the surface of the mantle and concave liners is oriented and transformed into the co-ordinate system coinciding with that of the base reference data using the referencing mean.

Alternatively, during a crusher reline, a scan of the surface of the bare mantle and concave (i.e., surface of the concave 19 and mantle 16 without the liners 21, 22 in place) can be performed to obtain point cloud data representing the surface of the bare mantle 16 and concave 19 (or the surface of the back of mantle and concave liners). The point cloud data representing the surface of the bare mantle 16 and concave 19 can be obtained by performing a series of scans about the bare mantle 16 and then registering the series of scans in a similar manner as described above.

Still alternatively, the base reference data representing the bare mantle 16 and the concave 19 can be determined by identifying fixed structures with known offsets to the surface of the bare mantle 16 or concave 19. For example, as shown in FIG. 16, the bole holes 90 on the upper periphery of the concave 19 can be used to estimate the surface geometry of the bare concave 19 since the bole holes 90 typically has a known offset to the surface of the bare concave 19.

If an absolute positioning system, e.g., IMU, is used when scanning the surface of the bare mantle 16 and concave 19 (i.e., base reference), the co-ordinate system of point cloud data representing the base reference would coincide with the co-ordinate system of the point cloud data representing the mantle and concave liners since absolute positing referencing for each scan is used.

Accordingly, displacement data indicative of the thickness of the mantle and concave liners 21, 22 at any one particular point can be obtained by determining the relative displacement between the point cloud data representing the surface of the mantle and concave liners 21, 22 and the point cloud data representing the surface of the base reference at any one particular point with the point cloud data having the same (or aligned) co-ordinate system.

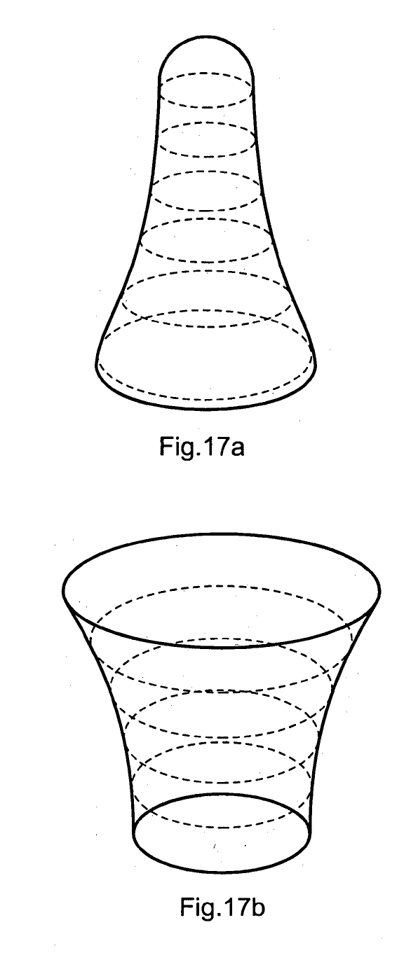

If an absolute positioning system is not used when scanning the surface of the mantle and concave liners 21, 22 and the surface of the bare mantle 16 and concave 19, a line of best fit method can be used to determine their orientations and thus their co-ordinate systems. The line of best fit method will now be described with respect to the mantle and concave liners 21, 22 as depicted in FIGS. 17a and 17b. In relation to the concave liners 22, the complete or continuous point cloud data representing the surface of the concave liners 22 are processed to form rings of data. The rings of data form a plurality of parallel planes spaced apart from each other along the height of the concave liners as shown in FIG. 17b. A line of best fit is formed by connecting the centre points of each plane across the height of the concave liners. The line of best fit would therefore indicate the orientation of the point cloud data representing the concave liners and its co-ordinate system can thus be determined. In general, more accurate results can be obtained when more rings are projected along the height of the concave liners. For instance, the number of rings may range from 5 to 20.

The line of best fit method can also be used to determine the co-ordinate systems of the point cloud data representing the surface of the mantle liners as shown in FIG. 17a and the surface of the bare mantle 16 and concave 19 in a similar manner.

In order to obtain accurate displacement data indicative of the thickness of mantle and concave liners 21, 22 at any particular point, the sets of data is correlated. In particular, the point cloud data representing the surface of the mantle and concave liners 21, 22 is oriented and transformed into the co-ordinate system coinciding with that of the base reference data using the referencing mean:

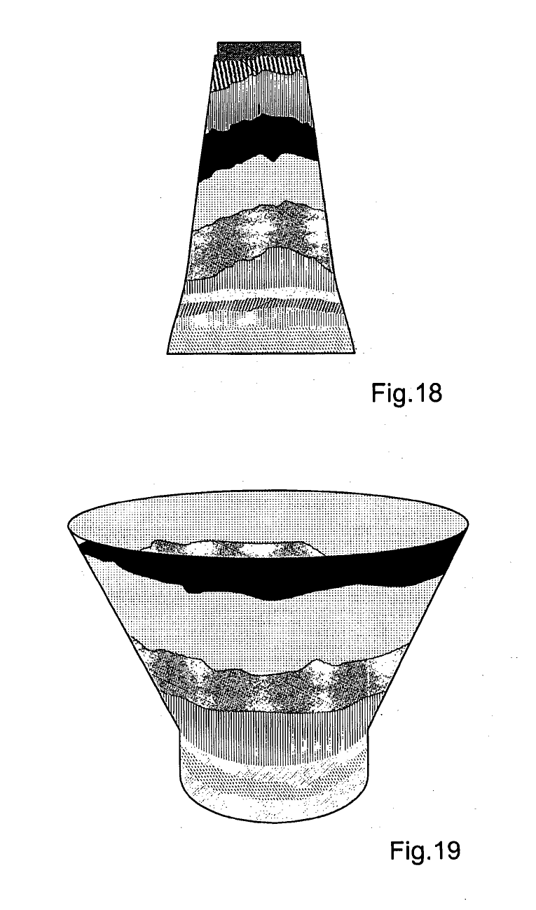

The displacement data can be processed to produce a number of condition monitoring deliverables, such as a three-dimensional realisation of the thickness of the mantle and concave liners 21, 22 as illustrated in FIGS. 18 and 19. The three-dimensional realisation can be shown in grey-scale as illustrated or colour coded to indicate the varying thickness over the surface of the mantle and concave liners 21, 22. The three-dimensional realisation may be provided by a software viewer executed on a computer and presented on a computer display for a user to visually examine the concave and mantle liners 22, 21 in the three-dimensional space.

The software viewer may also provide statistical information for each individual survey of the crusher 8 and can be analysed by a user to monitor the condition of the crusher liners such as to identify localised wear zones.

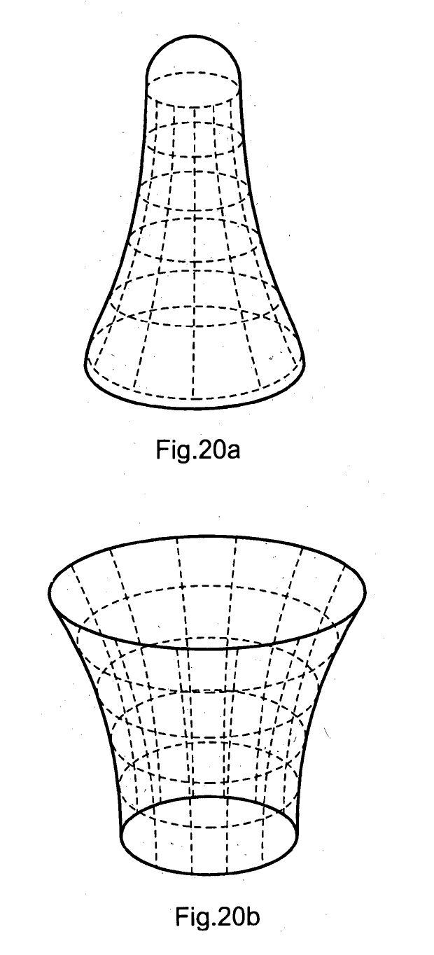

In addition, a wear rate of the mantle and concave liners 21, 22 at various sections can also be determined by comparing the thickness of the liners 21, 22 over time or over a number of surveys. In an embodiment, the point cloud data representing the surface of the mantle and/or concave liners 21, 22 are segmented into a plurality of sections in the form of a matrix as shown in FIGS. 20a and 20b. For example, the wear rate of the concave liner 22 at each point in which the lines forming the matrix intersect can be obtained by comparing the thickness of the concave liner 22 with one or more previously determined thicknesses of the concave liner 22 at each point.

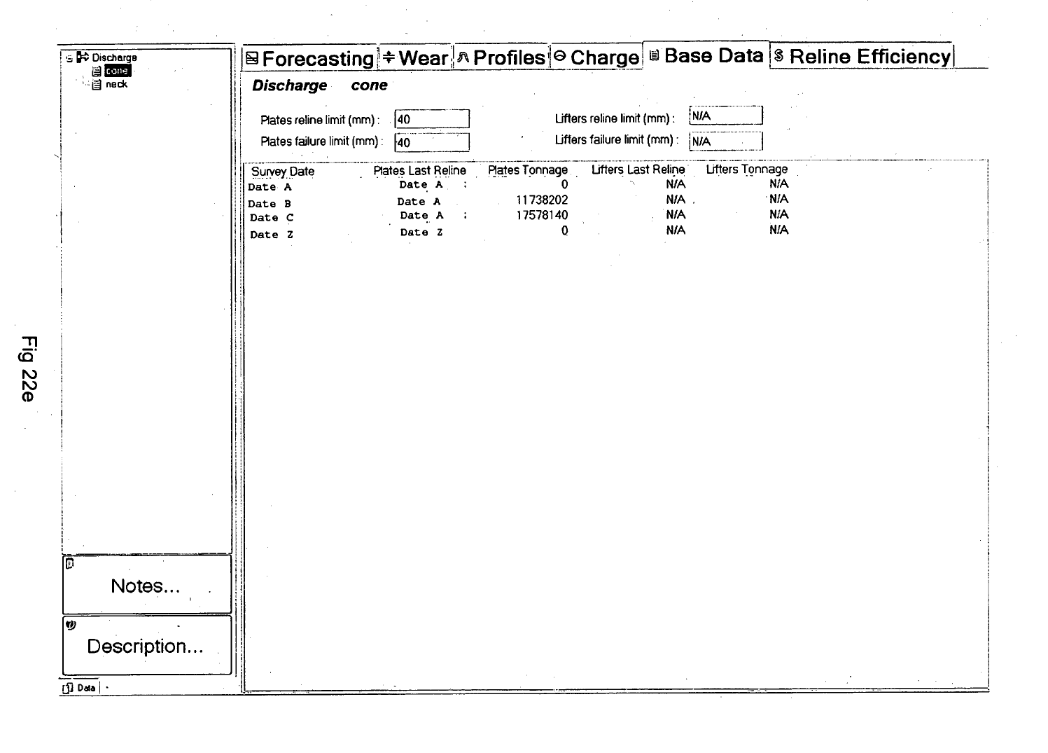

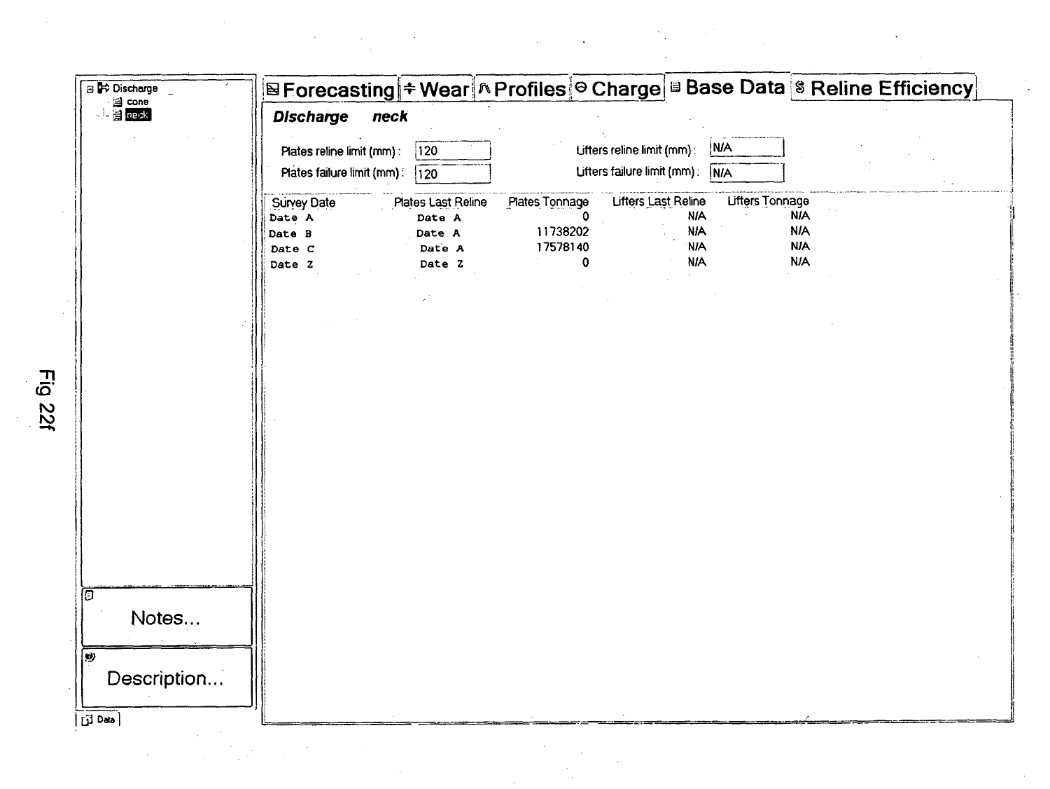

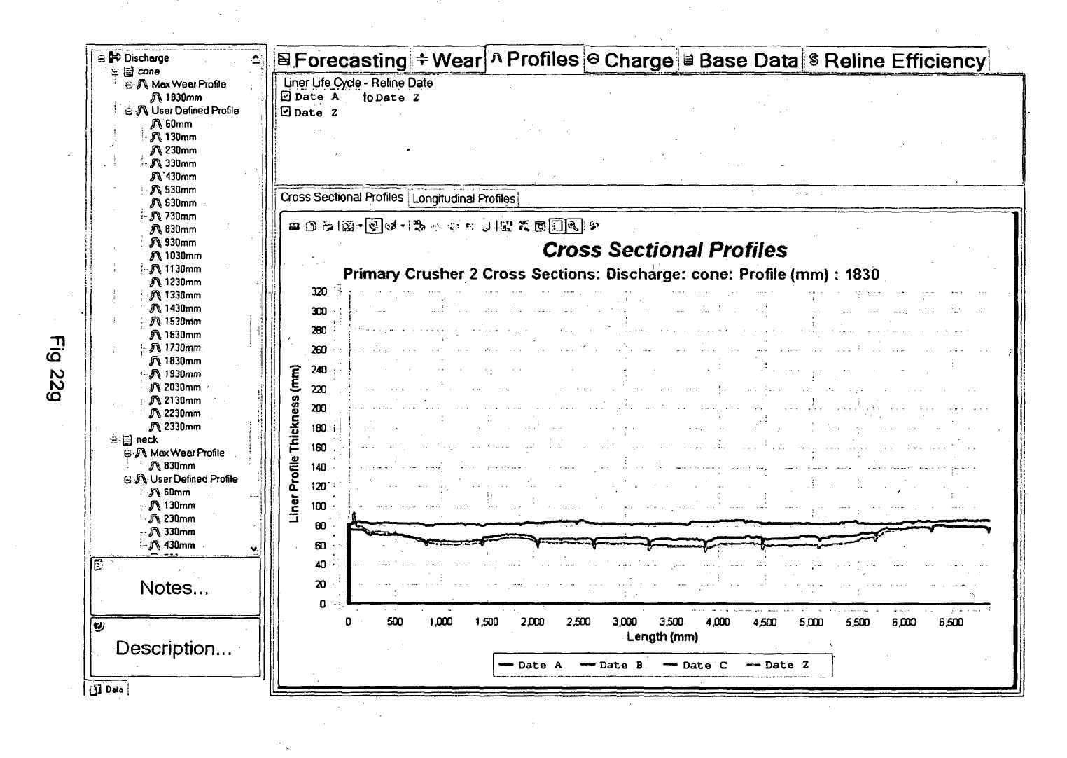

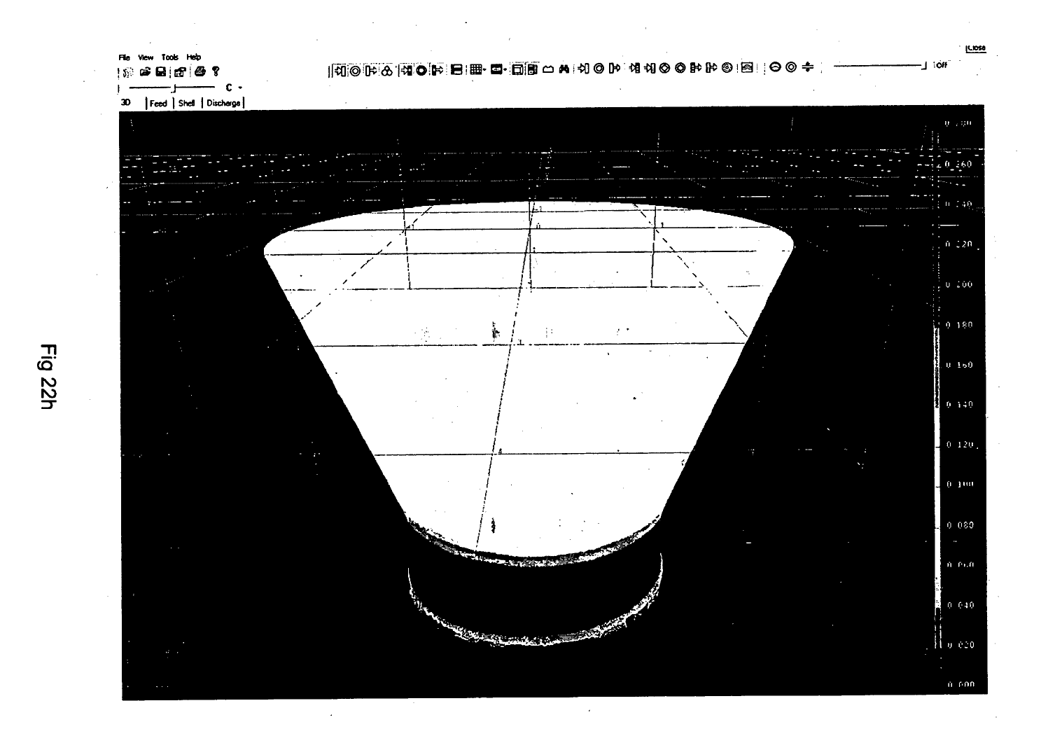

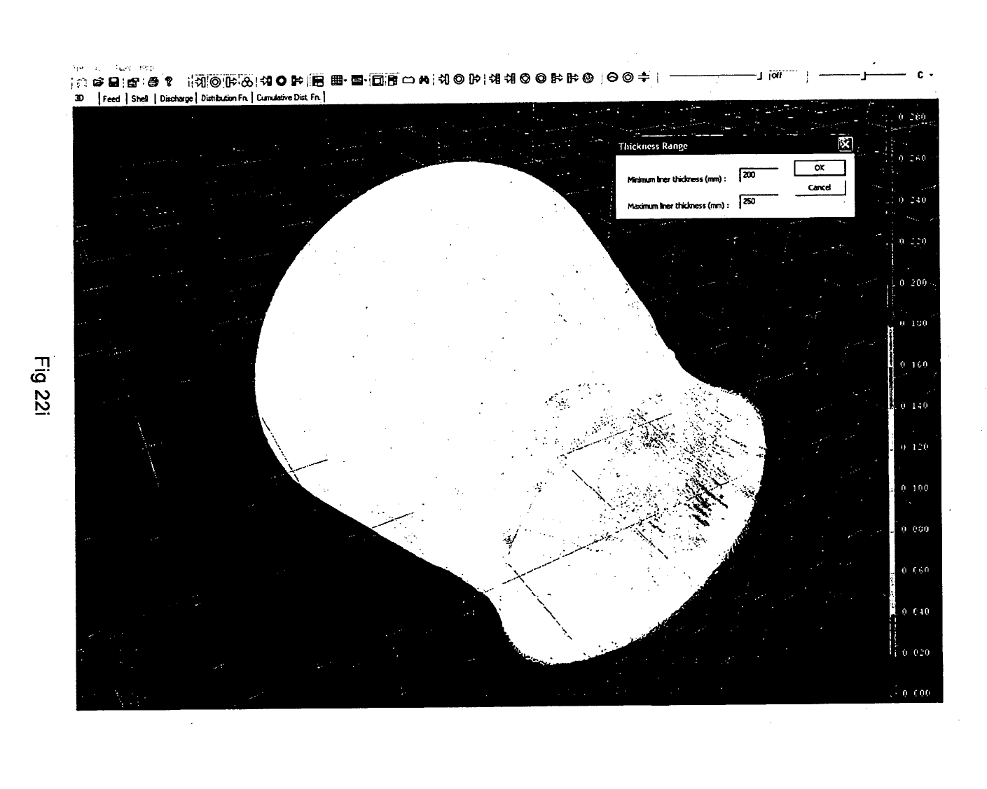

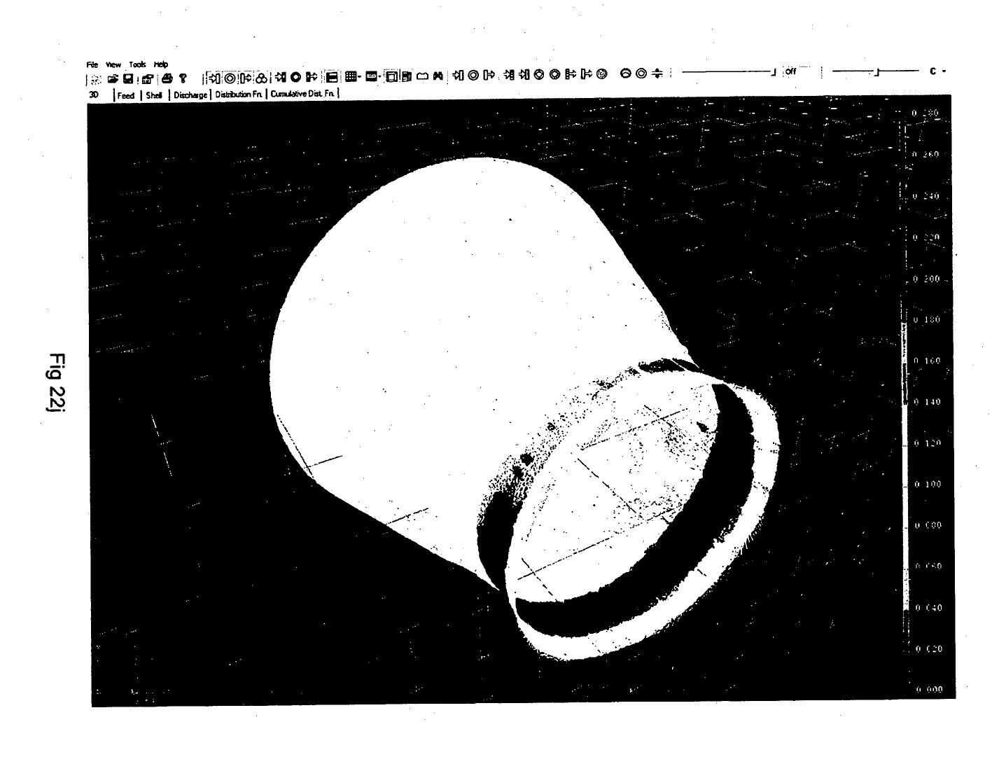

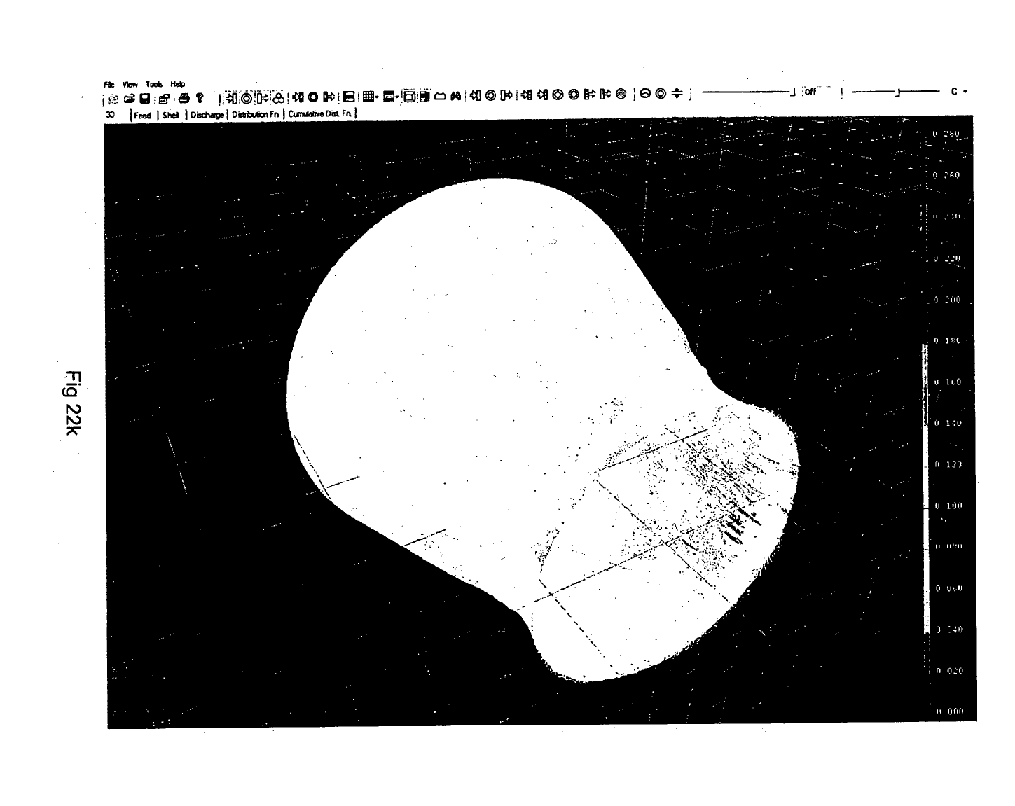

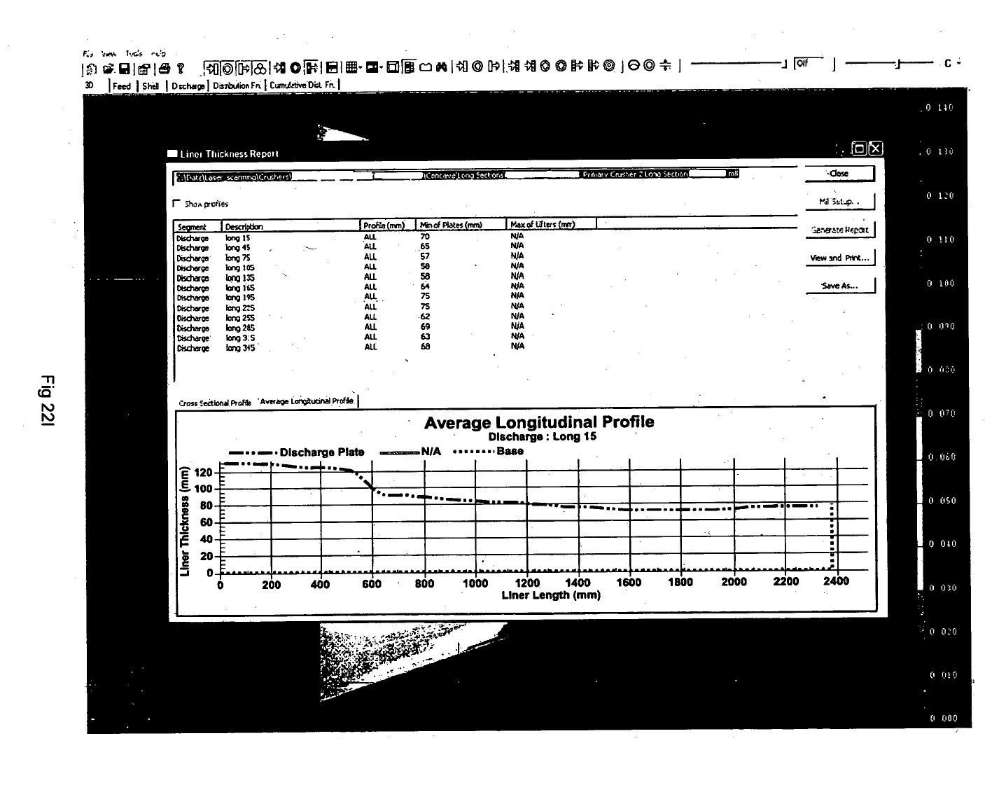

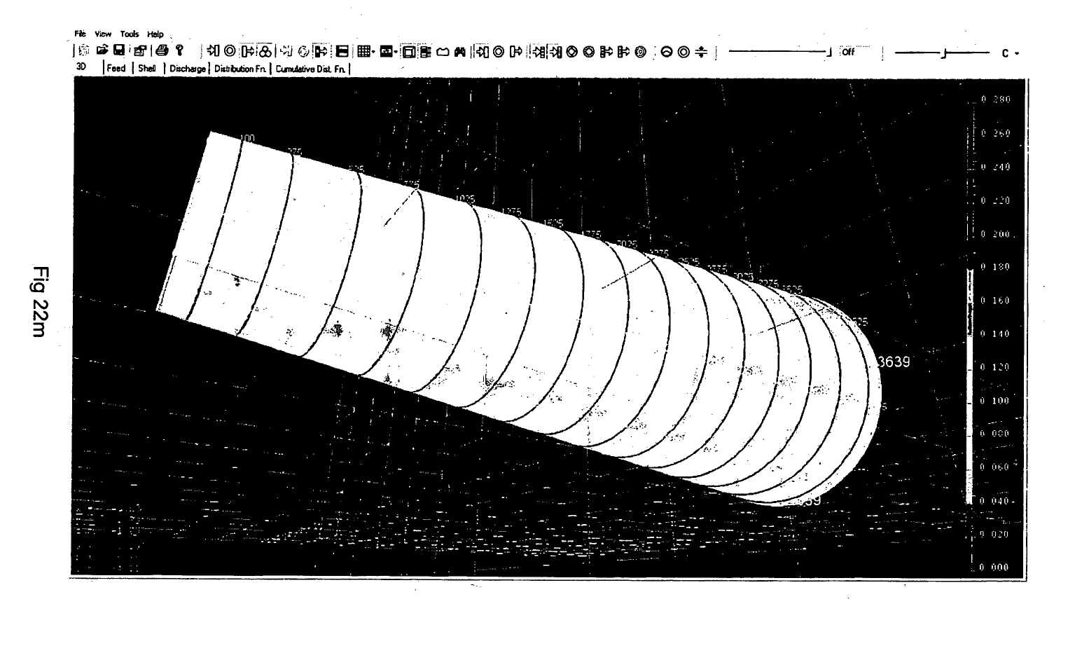

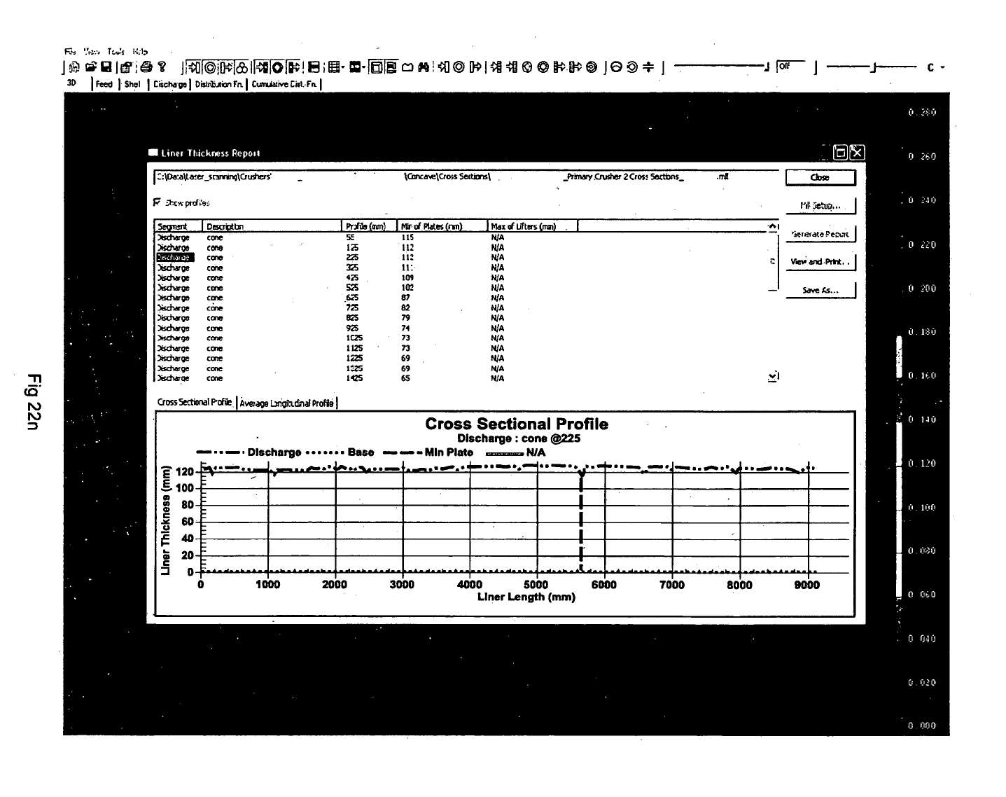

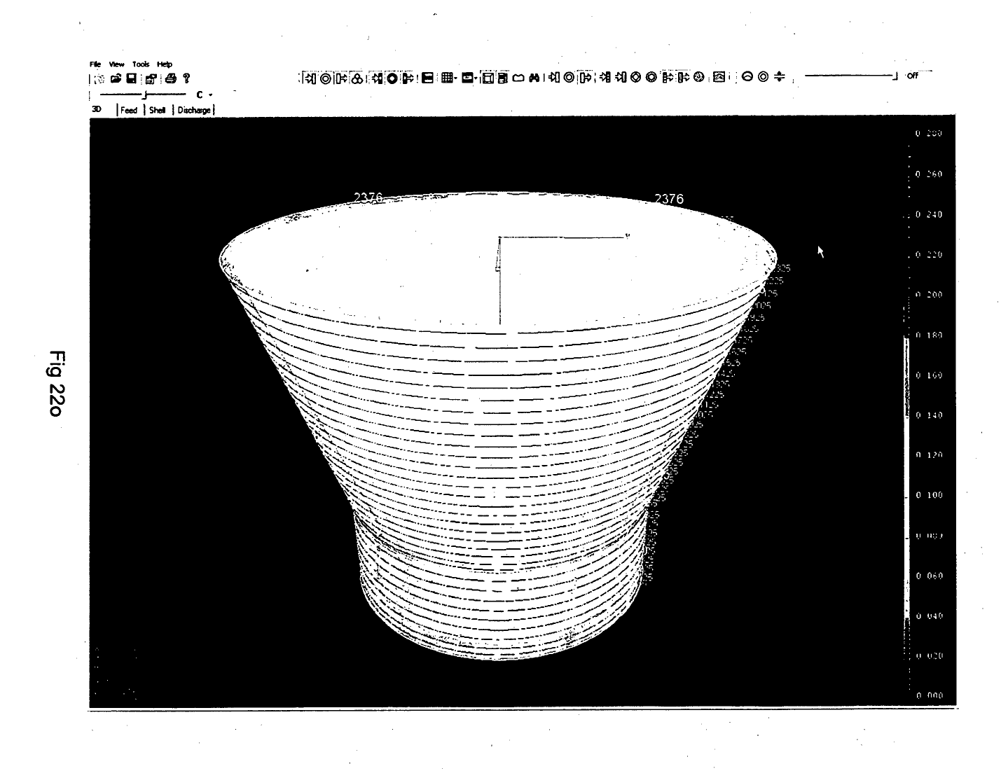

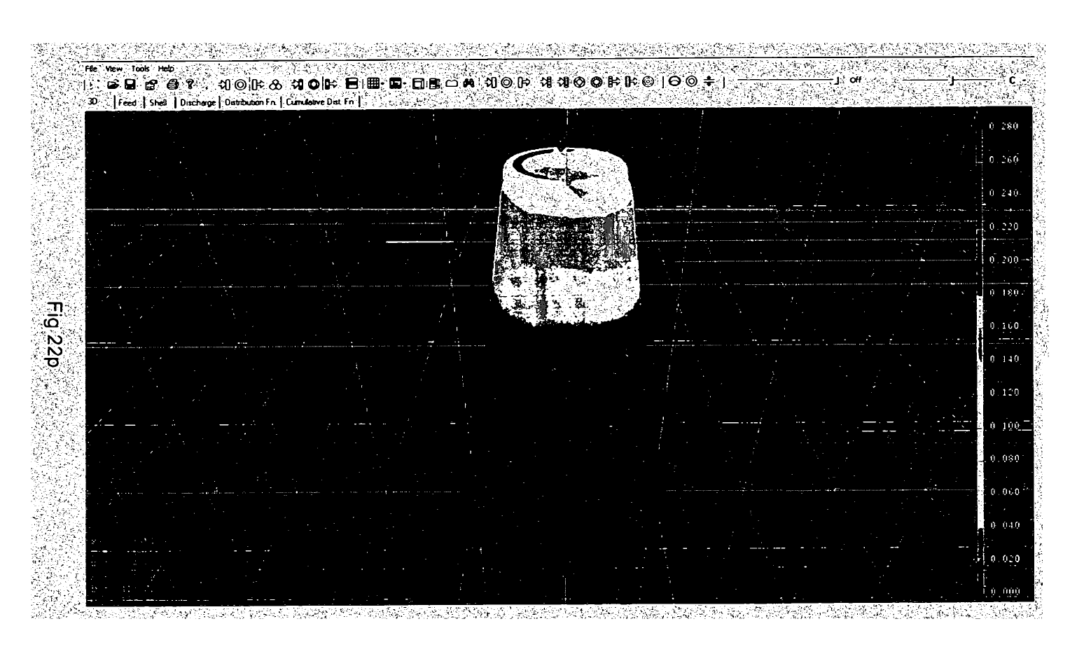

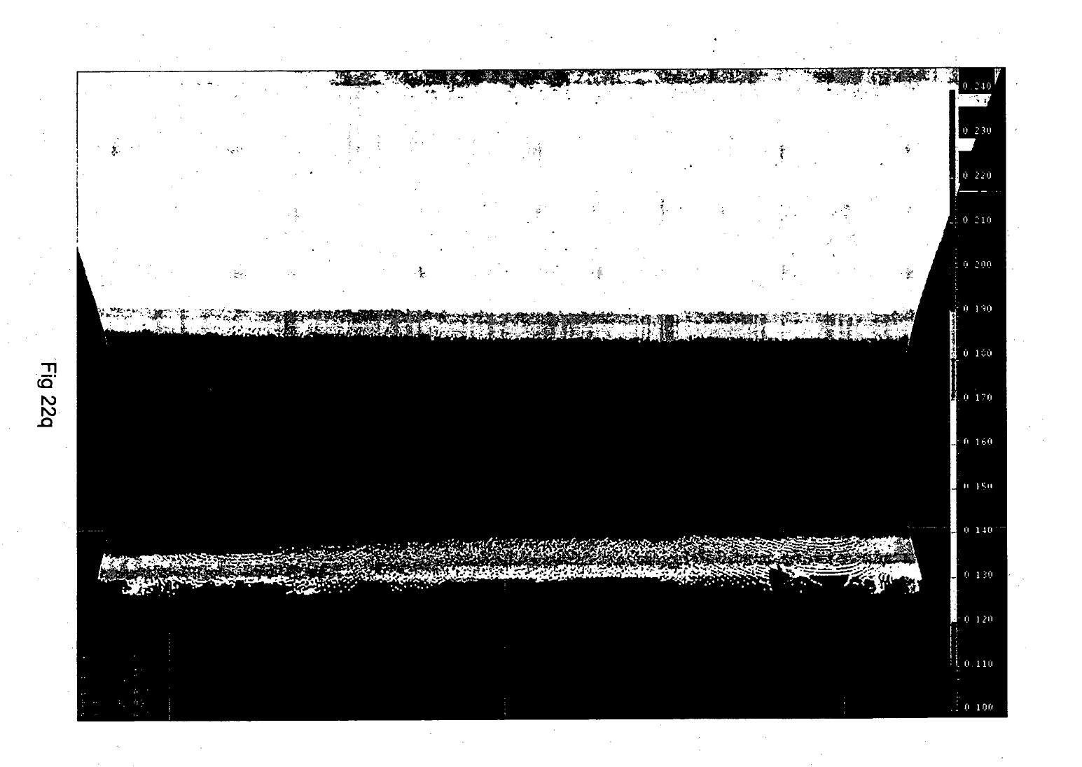

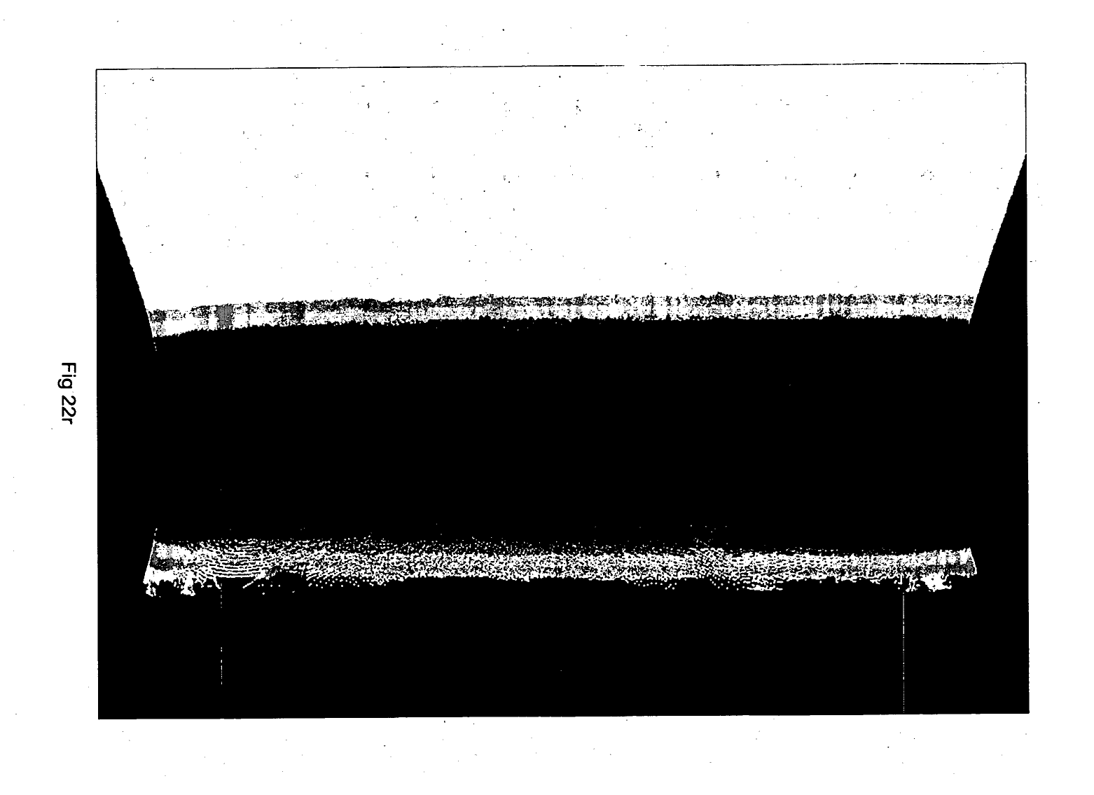

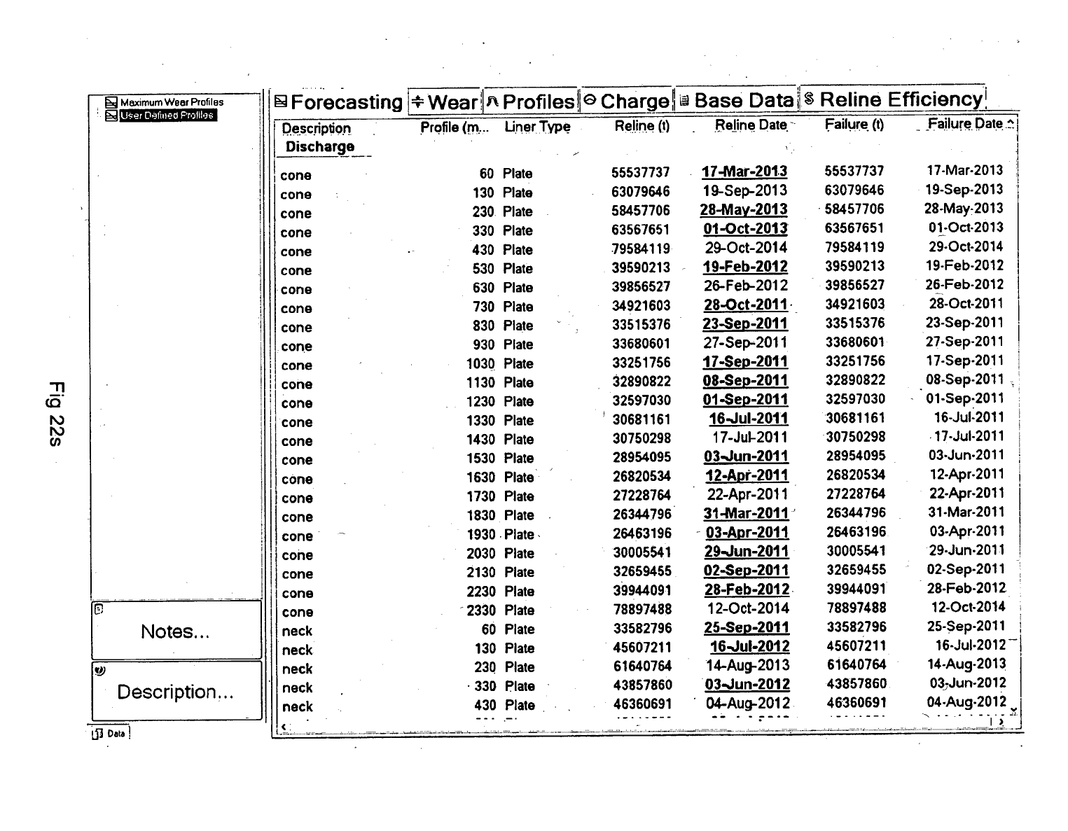

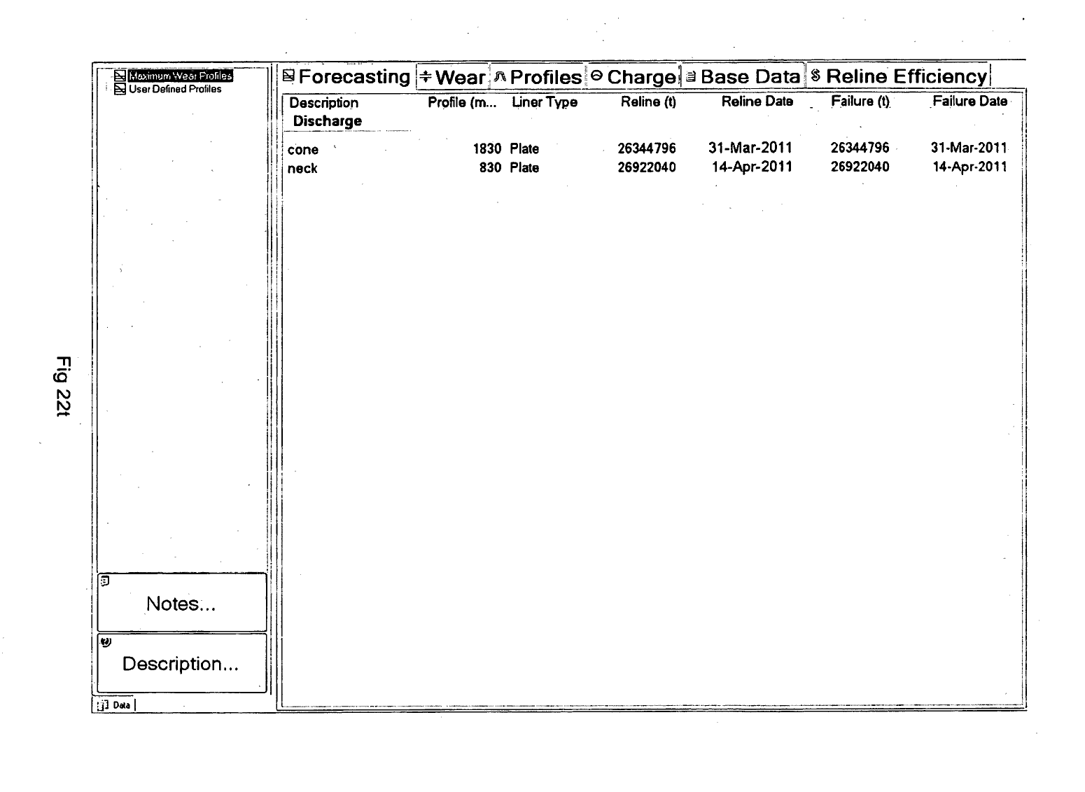

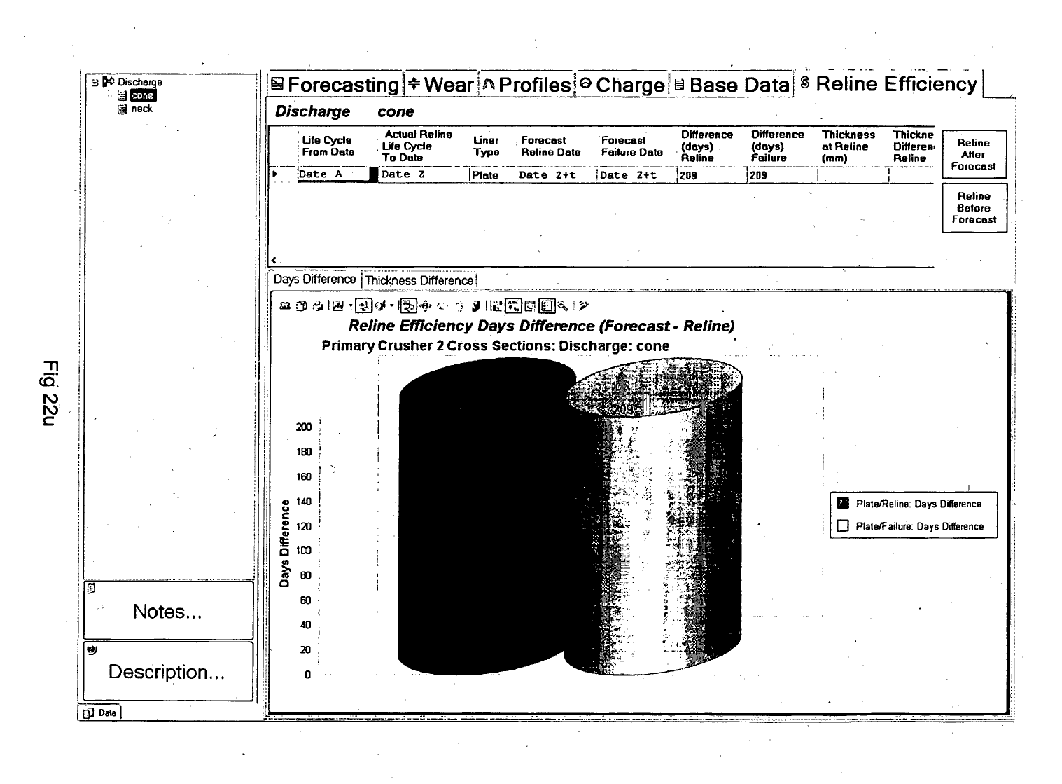

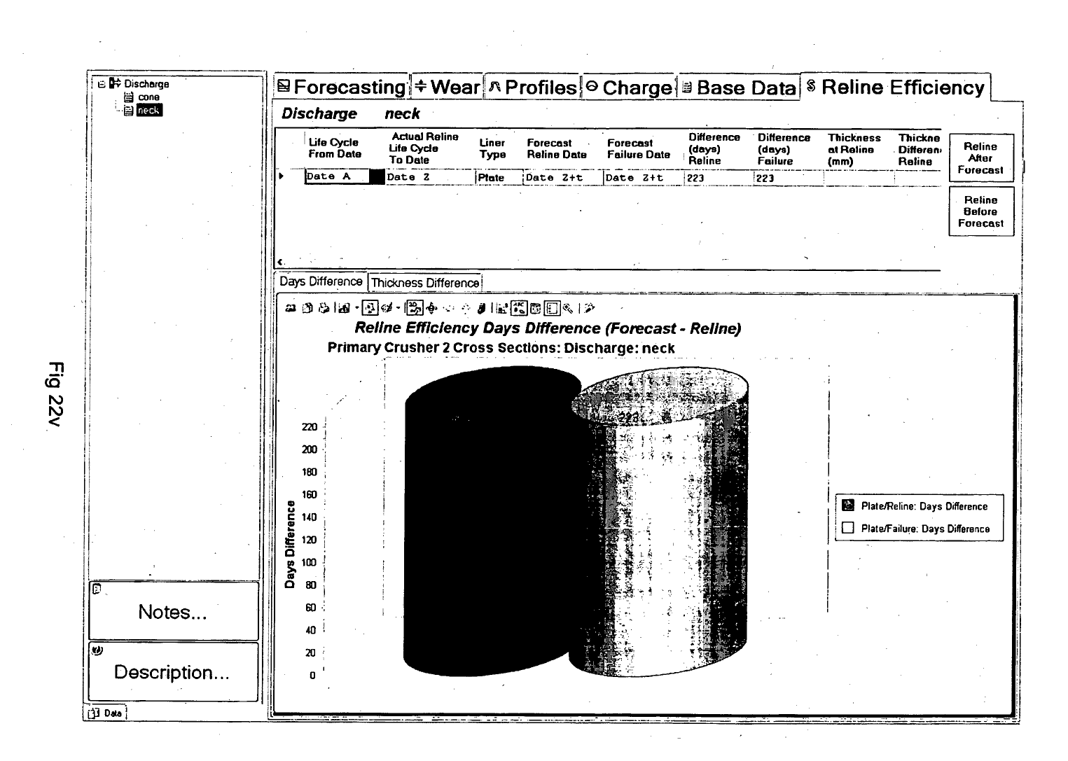

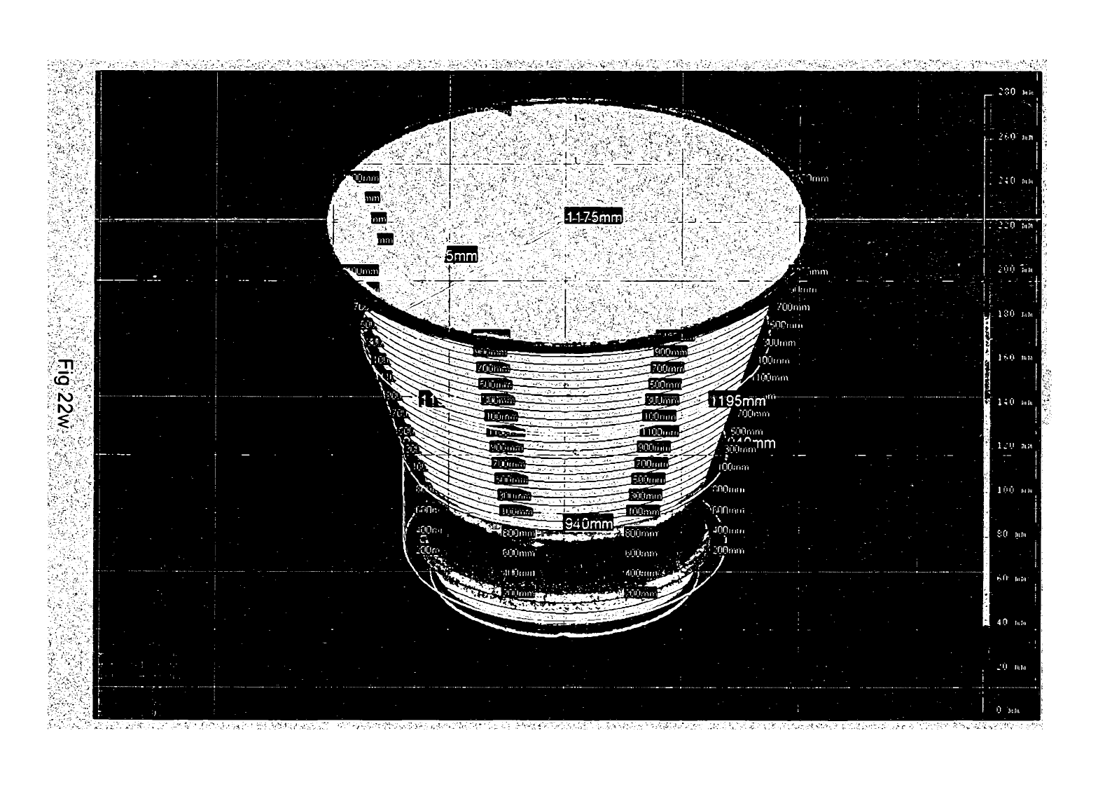

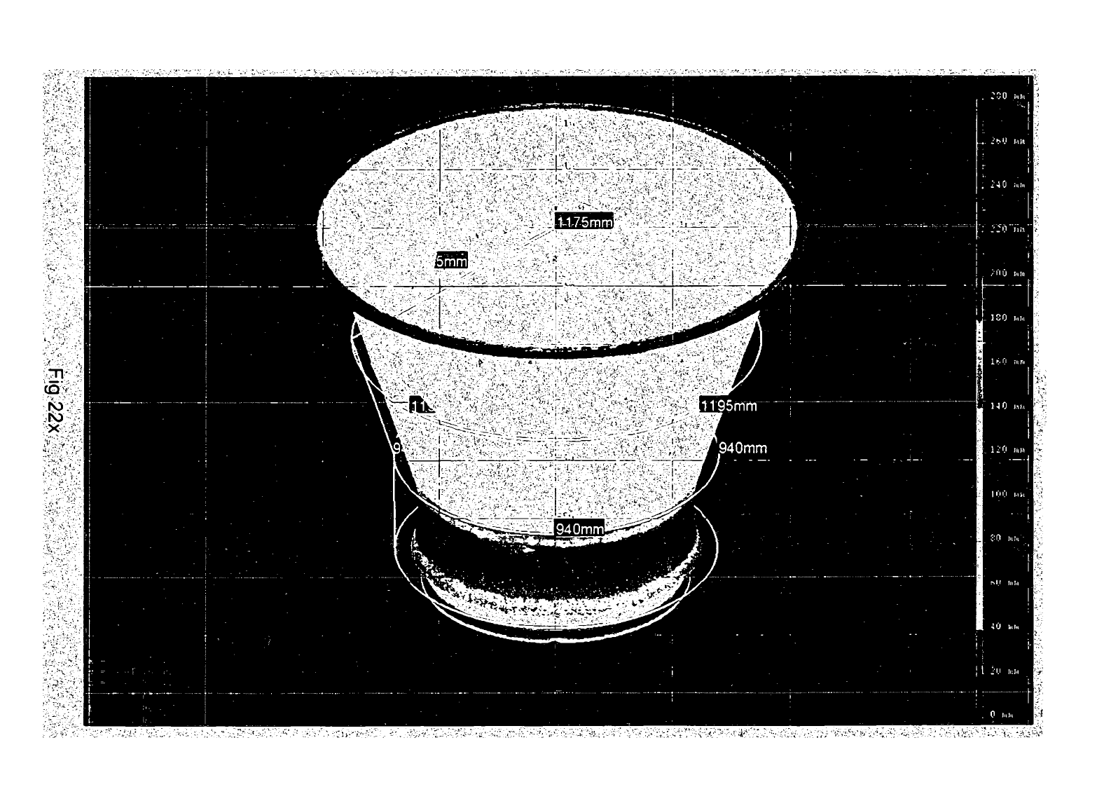

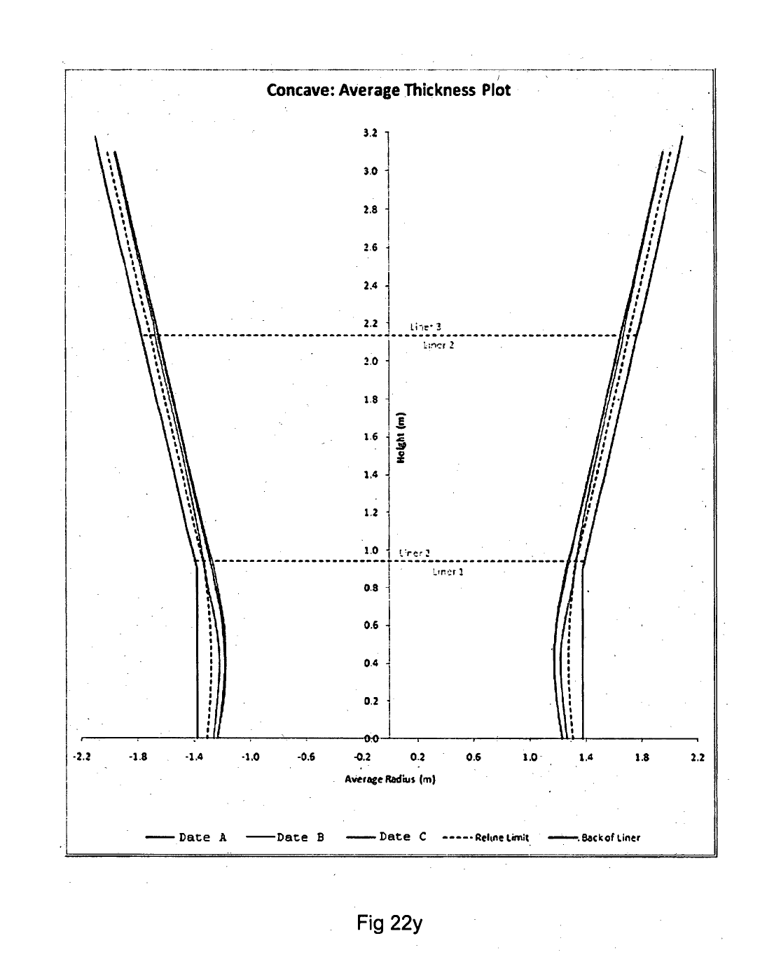

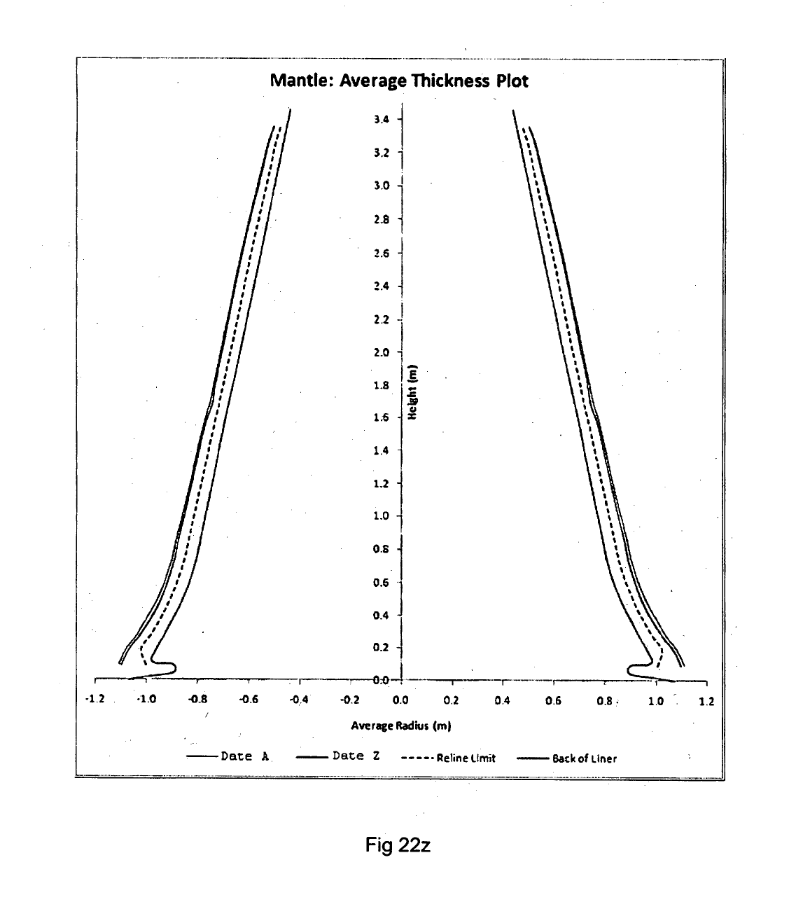

The wear rates obtained can be used to produce a number of monitoring deliverables such as identification of localised wear hot spots and reline forecasting. For example, the information may be provided by a wear report software executed on a computer and presented on a computer display to provide a series of statistical wear tracking information such as wear curves, forecasting tables, cross-sectional and longitudinal profile changes, and reline efficiency. An example of wear report showing the tonnage based wear tracking for an upper row of concave liners is shown in FIG. 22a.

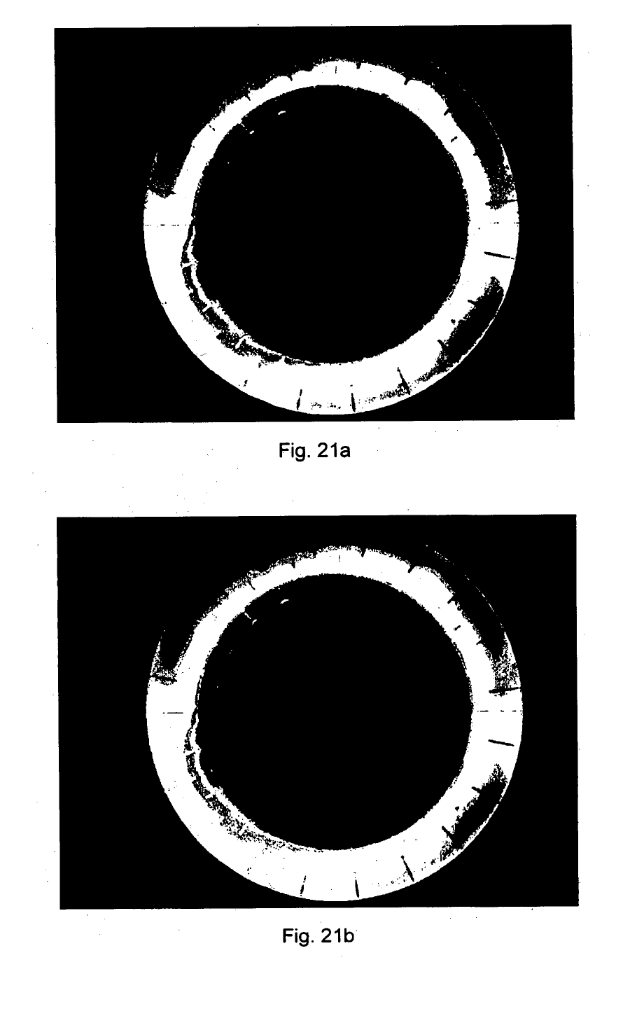

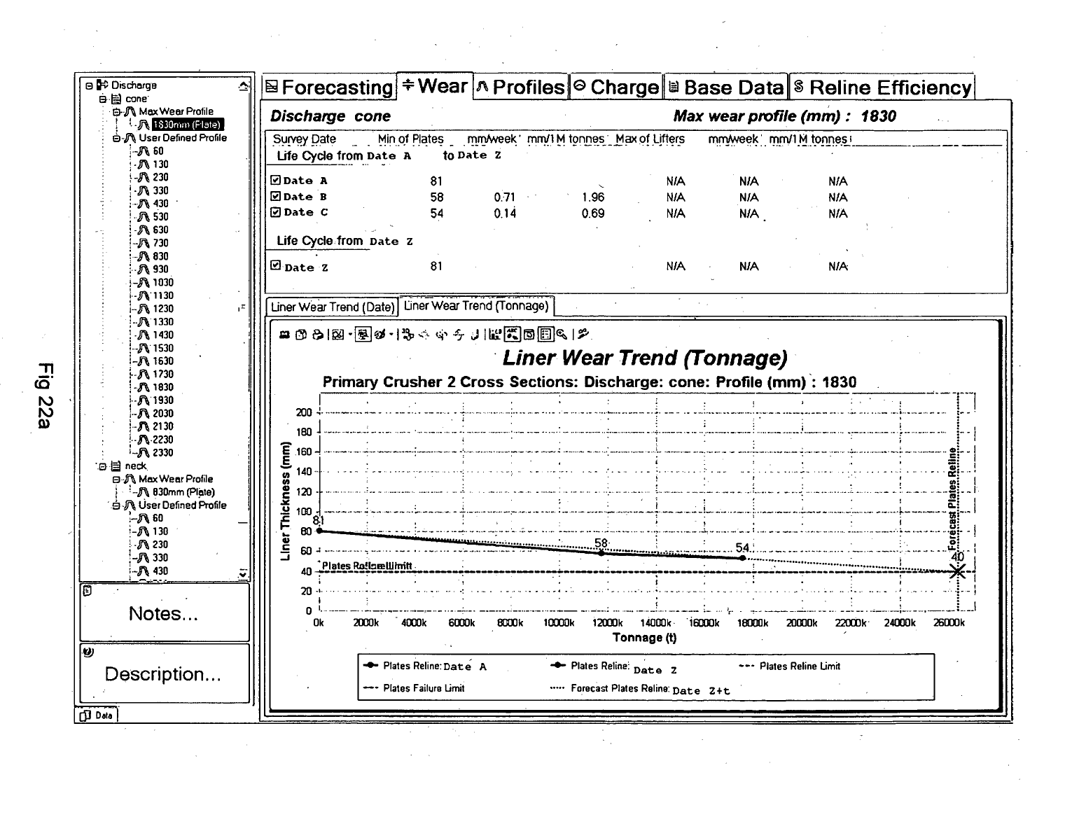

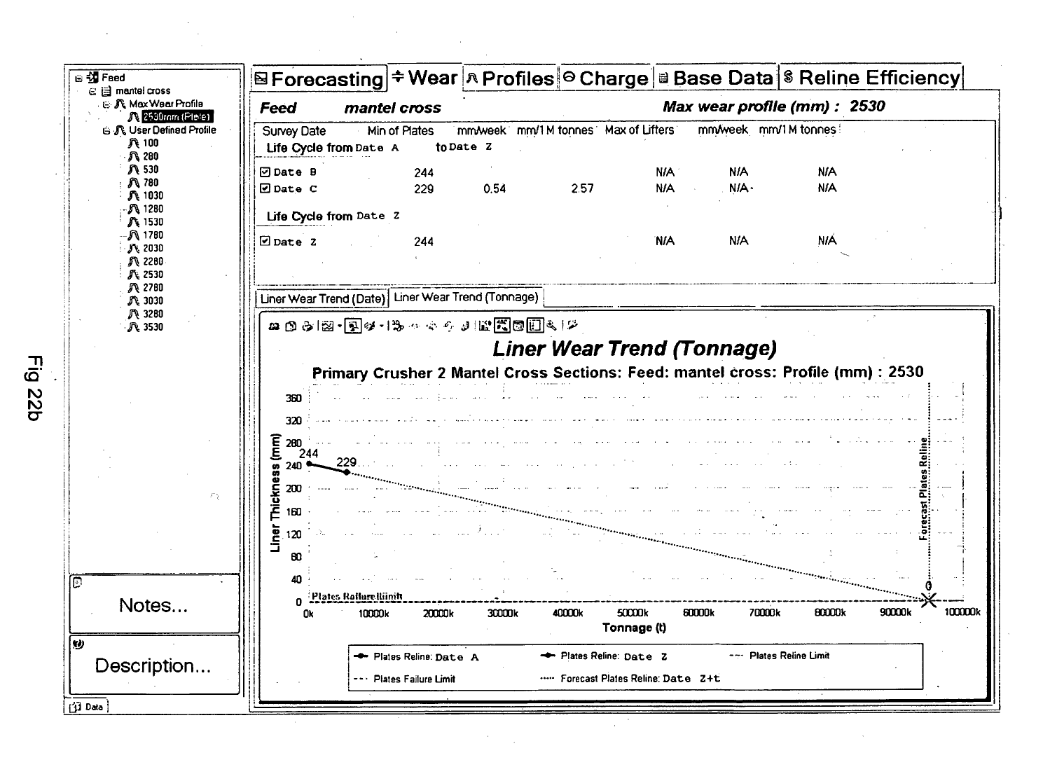

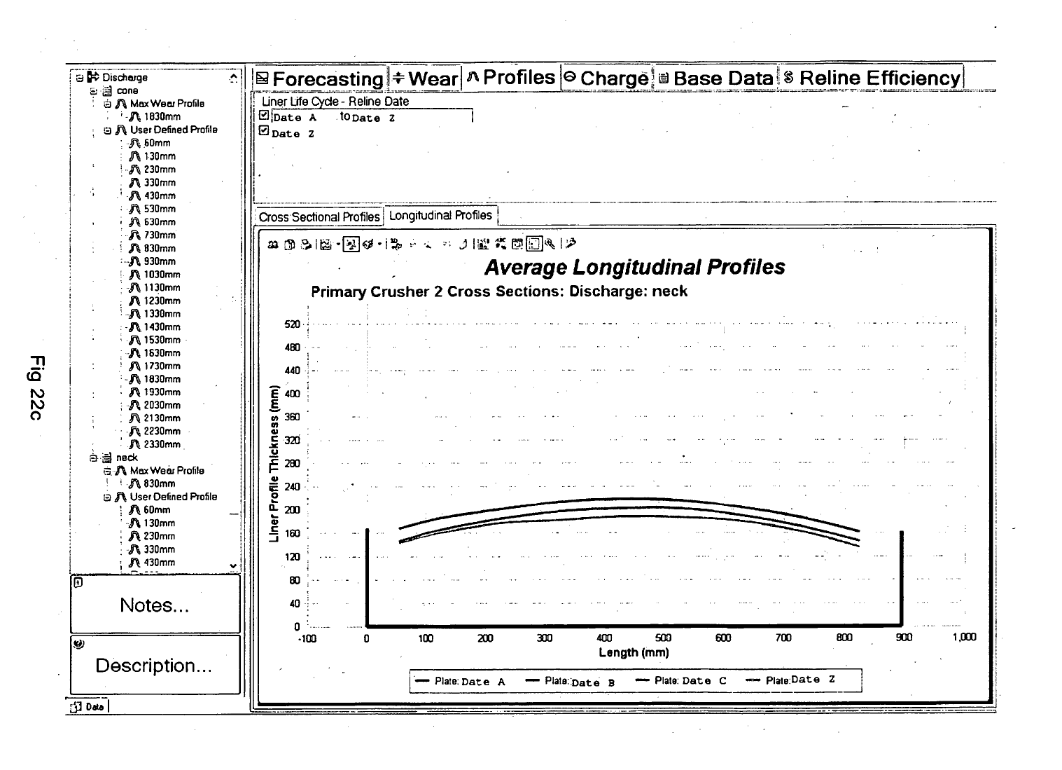

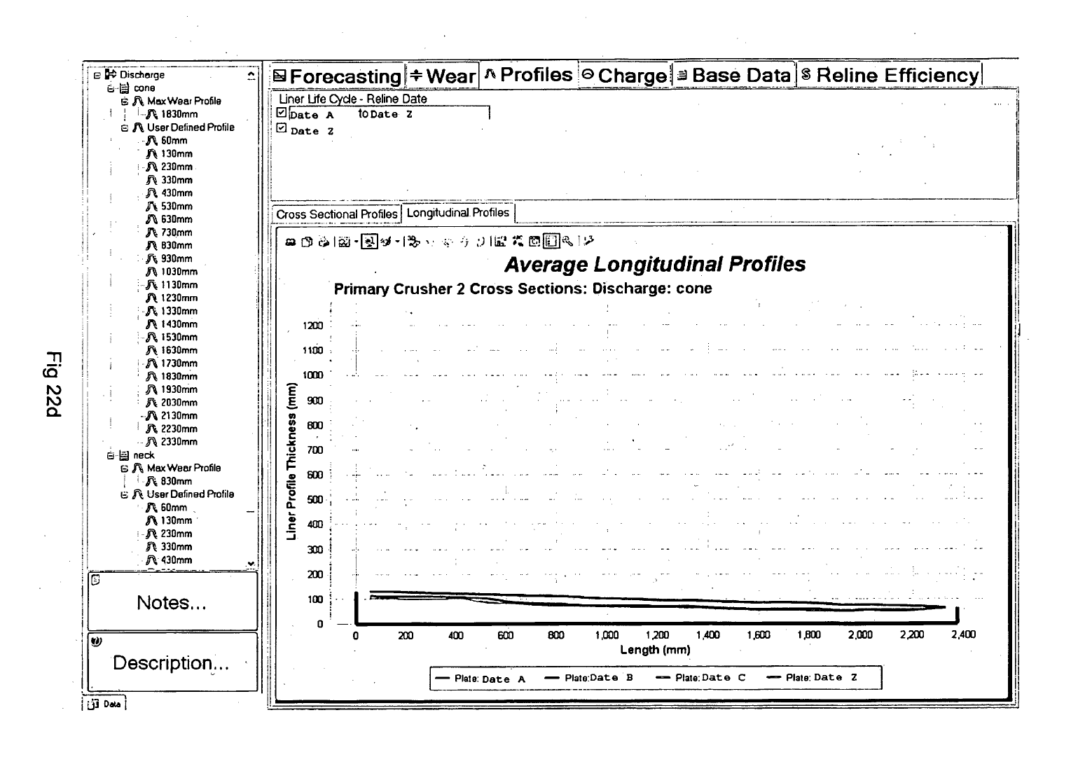

According to an embodiment of the present invention, the present system and method for monitoring the wear condition of a crusher can also monitor asymmetry wear in the mantle and concave liners 21, 22 by utilising the wear data obtained over time. FIGS. 21a and 21b illustrates an asymmetry wear result displayed by the software viewer on a computer display for a user to observe asymmetry issues in an upper row and a lower row of the concave liners 22. The knowledge of asymmetry wear issues on concave and mantle liners can for example be utilised in the design of concave and mantle liner 21, 22.

Preferably, the crusher 8 is operated at a substantially steady or constant target OSS and CSS in order to achieve stable product size for feeding downstream processing. As the concave and mantle liners 22; 21 wear, the OSS and CSS can be maintained substantially constant by raising the mantle 16 vertically upwards with respect to the concave 19. According to an embodiment of the invention, the CSS and/or OSS are tracked or monitored so that the mantle 16 can be raised upwards when the CSS and/or OSS exceeds a certain or predetermined limit. The CSS and OSS can be determined by calculating the distance between the concave and mantle liners 22, 21 in the vicinity of the bottom of the crusher 8 where the ores are crushed prior to leaving the crusher 8. The distance can be calculated based on the point cloud data representing the surface of the mantle liners 21 and the point cloud data representing the surface of the concave liners 22.

The CSS and OSS can also be tracked over time in order to determine the rate of change of the CSS and OSS. Once the rate of change of the CSS and OSS is obtained, for example, it is possible to forecast when the mantle 16 needs to be raised upwards in order to maintain the CSS and OSS.

In an embodiment of the present invention, the steps in data processing to produce condition monitoring deliverables for a series of two or more surveys during the same liner life cycle are generally described below and may include one or more of the following:
1.) Calculation of throughput tonnage based wear information at any location of the concave liners 22 from the three-dimensional thickness data;
2.) Calculation of throughput tonnage based wear information at any location of the mantle liners 21 from the three-dimensional thickness data;
3.) Calculation of reline forecast information for the mantle and concave liners 21, 22 based on wear tracking and reline limit definitions;
4.) Calculation of head replacement forecast information based on 1.) and 2.), target CSS and OSS as defined by maximum feed size target, head maximum possible vertical travel, and defined forecast loss of throughput caused by 1.) and 2.);
5.) Calculation of volumes at associated vertical and circumferential crusher cavity sections and determining choking or non-choking condition for each volumetric section;
6.) Calculation of % of crusher power/pressure limit reached per volumetric section of 5.);
7.) Calculation of vertical mantle adjustment settings per 12 hour site shift based on 4.), 5.) and 6.);
8.) Calculation of nip point angles at regular vertical crusher cavity positions at CSS;
9.) Calculation of annulus area at regular vertical intervals and tracking of minimum annulus area vertical position;
10.) Determination of localized wear hot spots;
11.) Calculation of circumferential wear asymmetry in concave liners;
12:) Calculation of circumferential wear asymmetry in mantle liners.

For example, with reference to FIGS. 22a to 22z, various screenshots are shown, for typical reports available using the system and method according to the embodiments of the present invention for monitoring the condition of mantle and concave liners 21, 22 of the gyratory crusher 8.

Modifications and variations such as would be apparent to a skilled, addressee are deemed to be within the scope of the present invention.

Throughout the specification, unless the context requires otherwise, the word “comprise” or variations such as “comprises” or “comprising”, will be understood to imply the inclusion of a stated integer or group of integers but not the exclusion of any other integer or group of integers.

Furthermore, throughout the specification, unless the context requires otherwise, the word “include” or variations such as “includes” or “including”, will be understood to imply the inclusion of a stated integer or group of integers but not the exclusion of any other integer or group of integers.

Additionally, throughout the specification, unless the context requires otherwise, the words “substantially” or “about” will be understood to not be limited to the value for the range qualified by the terms.

1-4. (canceled)

5. A support for a scanning device, the support being for use in a system for monitoring the condition of a surface of a crushing zone within a crusher having an inlet through which material for crushing is delivered into the crushing zone, the support comprising a frame structure adapted to be positioned above the crushing zone to support the scanning device wherein the frame structure comprise a plurality of legs adapted to rest on an area above the inlet of the crushing zone.

6. (canceled)

7. (canceled)

8. The support according to claim 5 wherein the frame structure comprises an upper frame section supported on the plurality of legs, the upper frame structure being adapted to support the scanning device.

9. The support according to claim 5 wherein the frame structure is adapted to be lifted and rotated to shift the scanning device from one position to another.

10. The support according to claim 5 further comprising a track along which the scanning device can be moved from one position to another.

11. The support according to claim 5 comprising a portion at a free end of an arm of a rocker breaker available on site at a location at which the crusher is operating.

12. The support according to claim 5 comprising a carrier adapted to be lowered into the crushing zone through the inlet, the carrier being adapted to engage a surface of the crusher in order to support the scanning device in a stable manner.

13. The support according to claim 5 comprising a frame structure adapted to be lowered into the crushing zone through the inlet, the frame structure being adapted to engage between opposed surfaces of the crushing zone in order to support the scanning device in a stable manner.

14. The support according to claim 5 comprising a beam adapted to be positioned within the crushing zone, with the beam being selectively movable whereby the scanning device can assume all necessary positions for scanning the entire target surface.

15-17. (canceled)

18. The support according to claim 5 wherein each of the plurality of legs is adjustable in height.

19. The support according to claim 5 wherein at least one leg of the plurality of legs is adjustable between an extended condition wherein the at least one leg is further from the remaining legs, and a retracted condition wherein the at least one leg is closer to the remaining legs.

20. The support according to claim 5 wherein each leg of the plurality of legs has a foot rotatably secured to an end thereof, whereby in use the foot engages a portion of the crusher to support the support thereupon.

21. The support according to claim 8 wherein the upper frame comprises a downwardly depending post for supporting the scanning device, the post being adjustable relative to the upper frame.

22. The support according to claim 5 wherein the frame structure is movable to shift the scanning device from one position to another.

23. The support according to claim 5 further comprising a track along which the support is movable from one position to another relative to the crusher.

24. A support for use in a system for monitoring the condition of a wear surface of a crusher, the support comprising a frame structure adapted to be positioned above the wear surface to support an imaging device wherein the frame structure comprises a plurality of legs adapted to rest on an area above the wear surface.
